(19) United States
(12) Patent Application Publication
(10) Pub. No.: US 2025/0199320 A1
(43) Pub. Date: Jun. 19, 2025

(54) AUGMENTED-REALITY HEADSET WITH A DISPLAY PROJECTOR ASSEMBLY, AN ELECTRONICS-HOLDING FRAME PLATE, AND A FRAME BACKPLATE

(71) Applicant: Meta Platforms Technologies, LLC, Menlo Park, CA (US)

(72) Inventors: Stephen James McNally, Sammamish, WA (US); Nicholas Daniel Trail, Bothell, WA (US); Yijing Fu, Bellevue, WA (US)

(21) Appl. No.: 19/069,107

(22) Filed: Mar. 3, 2025

Related U.S. Application Data
(63) Continuation-in-part of application No. 18/951,460, filed on Nov. 18, 2024.
(60) Provisional application No. 63/699,095, filed on Sep. 25, 2024.
(60) Provisional application No. 63/602,314, filed on Nov. 22, 2023.

(51) Int. Cl. G02B 27/01

(52) U.S. Cl. CPC G02B 27/0172; G02B 2027/0178

(57) ABSTRACT

An augmented-reality glasses comprises a plurality of panels of light emitters arranged to form an array of light emitters, wherein the array of light emitters includes light emitters of three colors; collimation optics for collimating light received from the array of light emitters; an optical coupler for receiving the collimated light; and a three-channel waveguide combiner for display of augmented-reality content to a wearer of the augmented-reality glasses, wherein each channel of the three-channel waveguide combiner respectively causes display of images of one color of the three colors generated by the light emitters. In some embodiments, the three-channel waveguide combiner is an optical waveguide with pupil replication and the optical coupler is an in-coupling optical element for coupling the collimated light into the three-channel waveguide combiner.

### RELATED APPLICATION

This application is a continuation-in-part of U.S. Non-Provisional application Ser. No. 18/951,460 filed Nov. 18, 2024, entitled “Augmented-Reality Headset With An Electronics-Holding Frame Plate And A Frame Backplate,” which claims priority to U.S. Provisional Application Ser. No. 63/699,095, filed Sep. 25, 2024, entitled “Augmented-Reality Headset with an Electronics-Holding Frame Plate and a Frame Backplate, and a Display Projector Assembly and an Optical Stack for use in Rendering Augmented-Reality Content” and U.S. Provisional Application Ser. No. 63/602,314, filed Nov. 22, 2023, entitled “Augmented Reality Headset with An Electronics Holding Frame Plate And A Frame Backplate,” each of which is incorporated herein by reference.

### TECHNICAL FIELD

This relates generally to an augmented-reality headset configured for displaying an augmented reality environment, and the placement of electrical and non-electrical components within the augmented-reality headset to provide a positive user experience (e.g., comfort, usability, battery longevity, etc.). In particular, monochrome light emitter panels with an optical waveguide combiner for a display projector assembly portion of the augmented-reality headset is described.

### BACKGROUND

Traditional artificial reality headsets are usually inconvenient for the end user as they typically make sacrifices, in terms of weight, size, battery life, or performance. Most commonly these traditional artificial reality devices make sacrifices in size and weight, which can be uncomfortable and awkward for the user to wear. Even if the device is able to have a comfortable form factor, the device is usually heavily compromised in both performance and battery life.

As such, there is a need to address one or more of the above-identified challenges. A brief summary of solutions to the issues noted above are described below.

### SUMMARY

The devices described herein resolve the problems described above by creating a very compact, lightweight, small form factor, and high-performing pair of augmented reality glasses. In particular, the glasses described herein have a shape that is similar to non-augmented reality glasses. This is done by not utilizing off-the-shelf components and using components specifically designed for this form factor, as well as lightweight materials. In addition, the manufacturing techniques described herein allow for an efficient assembly by having a majority of electrical components attached to only one side of the lens frame.

Additionally, the devices and systems described herein use monochrome light emitting panels, separate optical paths for display images, and an optical waveguide combiner for providing a wide field-of-view and high pixel per degree resolution while maintaining small form factors and using light-weight components.

In an example head wearable device, the head-wearable device (e.g., an augmented-reality headset, as shown in FIGS. 1-4 and 8A, is configured to display an extended reality, including a mixed reality, a virtual reality, etc.), comprises a data communications antenna (e.g., at least one communications radio and antenna 107A and 107B shown in FIG. 1 are shown as being located on a bottom portion of the electronics-holding frame plate 102). The head-wearable device includes a projector (e.g., a projector, such as projector assemblies 116A and 116B shown in FIG. 1, which are configured to transmit light to a waveguide) and a display (e.g., a waveguide (e.g., waveguides 122A and 122B shown in FIG. 1), and/or a group of lenses and waveguides (e.g., lenses 128A and 128B, lenses 132A and 132B, and/or waveguides 122A and 122B) as shown in FIG. 1). The head-wearable device also includes a printed circuit board (PCB) for conveying data to and from the data communications antenna and the projector (e.g., printed circuit board 108 as shown in FIG. 1). The head-wearable device also includes a plurality of bumpers (e.g., front bumpers 126A and 126B, and rear bumpers 130A and 130B as shown in FIG. 1). An electronics-holding frame plate is also coupled to at least the PCB and the data communications antenna (e.g., electronics-holding frame plate 102 shown in FIGS. 1-3, and electronics-holding frame plate 400 shown in FIG. 4). In some embodiments, the PCB is positioned and resides within a cavity of the electronics-holding frame plate (e.g., printed circuit board is described as being positioned and residing within a cavity of the electronics-holding frame plate 102 in FIG. 1). In some embodiments, the data communications antenna partially resides within the cavity of the electronics-holding frame plate such that a portion of the data communications antenna is exposed to an external environment (e.g., FIG. 1 shows the communications radio and antenna 107A and 107B being placed flush or substantially flush with the underside of the electronics holding frame plate 102, where at least a portion of communications radio and antenna 107A and 107B are located within the cavity of the electronics holding frame plate 102). In some embodiments, a portion of the data communications antenna is overmolded with the electronics-holding frame plate, and after overmolding, the data communications antenna and the electronics holding frame plate are machined together to produce a seamless surface. The augmented-reality headset also includes a frame backplate (e.g., backplate portion 114 shown in FIG. 1, backplate portion 202 shown in FIG. 2, and backplate portion 402 shown in FIG. 4) configured to couple with the electronics-holding frame plate and enclose the data communications antenna, the projector, the display, the plurality of bumpers, and the PCB within the cavity of the electronics-holding frame plate. In some embodiments, a first bumper of the plurality of bumpers forms a first gap between the PCB and the display (e.g., FIG. 1 shows that front bumpers 126A and 126B have a first size (e.g., thickness), which defines a first gap between the PCB 108 and waveguides 122A and 122B), and a second bumper of the plurality of bumpers forms a second gap between the display and the frame backplate (e.g., FIG. 1 shows that rear bumpers 130A and 130B have a second size, as compared to the front bumpers 126A and 126B, which defines a second gap between the waveguides 122A and 122B and the backplate portion 114).

Having summarized the first aspect generally related to an augmented-reality headset with specific components placed within an electronics-holding frame plate above, the second aspect generally related to mounting a lens and/or waveguides within an augmented-reality headset to avoid damage and vibrations during use is now summarized.

In another augmented-reality headset, the augmented-reality headset (e.g., augmented-reality headset 100 shown in FIG. 1) comprises one or more lenses (e.g., a lens that is configured to have a user interface that is projected onto it from a display projector assembly) within a housing of the artificial-reality headset, and at least one of the one or more lenses is configured to present an augmented-reality user interface to a wearer of the artificial-reality headset (in some embodiments, the artificial-reality headset is further configured to display an immersive virtual reality) (e.g., waveguides 122A and 122B shown in FIG. 1 and waveguide 301 shown in FIG. 3). The augmented-reality headset includes one or more flexures (e.g., four flexures located around a perimeter of a lens) coupled to a lens of the one or more lenses (e.g., FIG. 3 illustrates how a plurality of flexures (300A, 300B, 300C, and 300D) that are coupled with waveguide 301), and each respective flexure of the one or more flexures is configured to (i) compress when a force (e.g., a drop shock force) is applied to the housing, thereby reducing a load received at the lens, and (ii) be coupled to the lens to orient the lens to have a predetermined orientation within the housing (e.g., FIG. 3 shows that the flexures also include tabs (302A, 302B, 302C, and 302D) that are configured to be inserted into respective troughs (304A, 304B, 304C, and 304D) located on the electronics holding frame plate 102). In some embodiments, the flexures are placed at locations statistically most likely to be the first contact locations when the artificial-reality headset is dropped. The statistically most likely first contact locations during a drop can be determined based on common holding techniques and center of gravity of the artificial reality headset.

Having summarized the second aspect generally related to flexures that are placed around lenses and waveguides to reduce vibration and impact forces above, the third aspect generally related to a lens and waveguide assembly that includes a plurality of bumpers is now summarized.

In one example augmented-reality headset, the augmented-reality headset comprises a first lens (e.g., lenses 132A and 132B shown in FIG. 1) surrounded by a first bumper (e.g., rear bumpers 130A and 130B as shown in FIG. 1), and a waveguide (e.g., waveguides 122A and 122B shown in FIG. 1) positioned in front of the first lens. The augmented-reality headset also comprises a second lens (e.g., lenses 128A and 128B shown in FIG. 1) surrounded by a second bumper (front bumpers 126A and 126B shown in FIG. 1), and a projector assembly (e.g., projector assemblies 116A and 116B shown in FIG. 1) configured to direct light onto the waveguide to create an augmented-reality experience for a wearer of the augmented-reality headset, the display projector assembly being positioned between the waveguide and the second lens (e.g., as illustrated in FIG. 1).

Having summarized the third aspect generally related to a lens and waveguide assembly that includes a plurality of bumpers above, the third aspect generally related to an intermediary portion of an augmented-reality headset that is configured to house one or more components is now summarized.

In another example augmented-reality headset, the augmented-reality headset comprises an intermediary component attached to a glasses frame configured to house (e.g., protrusions 106A-106B shown in FIG. 1, and recessed side regions 200 shown in FIG. 2) a simultaneous localization and mapping (SLAM) camera placed on a first side of the intermediary component (e.g., FIG. 2 illustrates one or more side SLAM camera(s) 208 facing away from a wearer's face), wherein the SLAM camera is configured to map a portion of an environment surrounding the augmented-reality headset. The intermediary component is also configured to house an eye-tracking camera located on a second side of the intermediary component, where the second side is opposite to the first side of the intermediary component, and the eye-tracking camera is configured to track one or both eyes of a wearer (e.g., one or more eye-tracking camera(s) 206 shown in FIG. 2 is opposite to the SLAM camera 208).

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an exploded view of an augmented-reality headset that illustrates locations of a plurality of components configured to aid in the display of an augmented reality, in accordance with some embodiments.

FIG. 2 shows another embodiment in which the backplate portion includes at least one recessed-side region that is configured to house one or more electronic components, in accordance with some embodiments.

FIG. 3 illustrates how a plurality of flexures that are coupled with a lens or waveguide interface with the electronics holding frame plate, in accordance with some embodiments.

FIG. 4 illustrates shut-off ledges interface that is configured to ensure the electronics-holding frame plate and the backplate portion share a common ground, in accordance with some embodiments.

FIG. 5 also illustrates a non-comprehensive list of a plurality of components that can optionally be included in the augmented-reality headset, either alone or in combination.

FIGS. 6A-6B illustrate example artificial-reality systems, in accordance with some embodiments.

FIGS. 7A-7B illustrate an example wrist-wearable device 700, in accordance with some embodiments.

FIGS. 8A, 8B-1, 8B-2, and 8C illustrate example head-wearable devices, in accordance with some embodiments.

FIGS. 9A-9B illustrate an example handheld intermediary processing device, in accordance with some embodiments.

FIG. 10 illustrates the projector and lens assembly used in an augmented-reality headset, in accordance with some embodiments.

FIG. 11 illustrates a partial exploded view of a display projector and lens assembly, in accordance with some embodiments.

FIG. 12 illustrates an exploded view of a display projector assembly used in an augmented-reality headset, such as those shown in the preceding Figures, in accordance with some embodiments.

FIG. 13 shows an example illustration of panels of light emitters for generating color images for display by a display projector assembly, in accordance with some embodiments.

FIG. 14 shows an example illustration of panels of light emitters with collimation optics for a display projector assembly, in accordance with some embodiments.

FIG. 15A shows example illustrations of exploded views of collimation optics coupled with light emitter panels for a display projector assembly, in accordance with some embodiments.

FIG. 15B shows example illustrations of collimation optics coupled with light emitter panels for a display projector assembly, in accordance with some embodiments.

FIG. 16 shows an example illustration of a three-channel waveguide combiner for a display projector assembly, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation of one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

Turning to the figures, an example head-worn device (e.g., an augmented-reality headset) will be described herein that is configured in a manner to provide a comfortable device with desired performance characteristics, while being easily assembled.

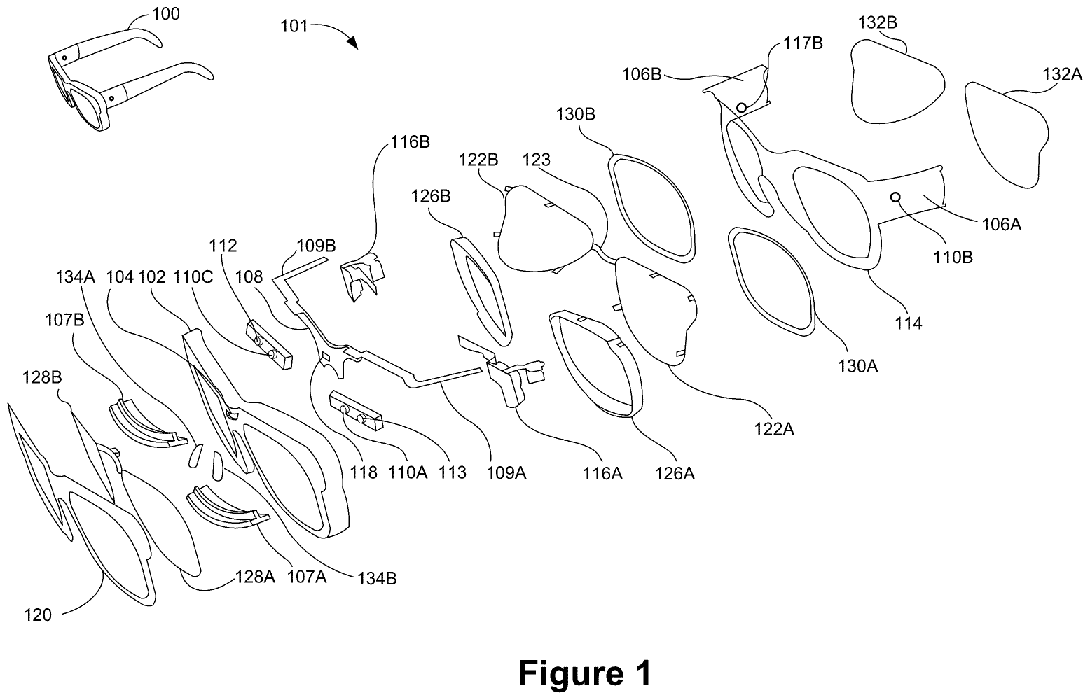

FIG. 1 illustrates an exploded view 101 of an augmented-reality headset 100 that illustrates locations of a plurality of components configured to aid in the display of an augmented-reality, in accordance with some embodiments.

FIG. 1 shows an electronics-holding frame plate 102 (e.g., a front plate) of a glasses frame has a cavity portion that is configured to be coupled to a plurality of electronic components and a plurality of non-powered components. In some embodiments, the electronics-holding frame plate 102 is constructed of a lightweight metal or alloy (e.g., aluminum, magnesium, etc.) or a composite material (e.g., a metal matrix composite, a fiber reinforced composite, etc.).

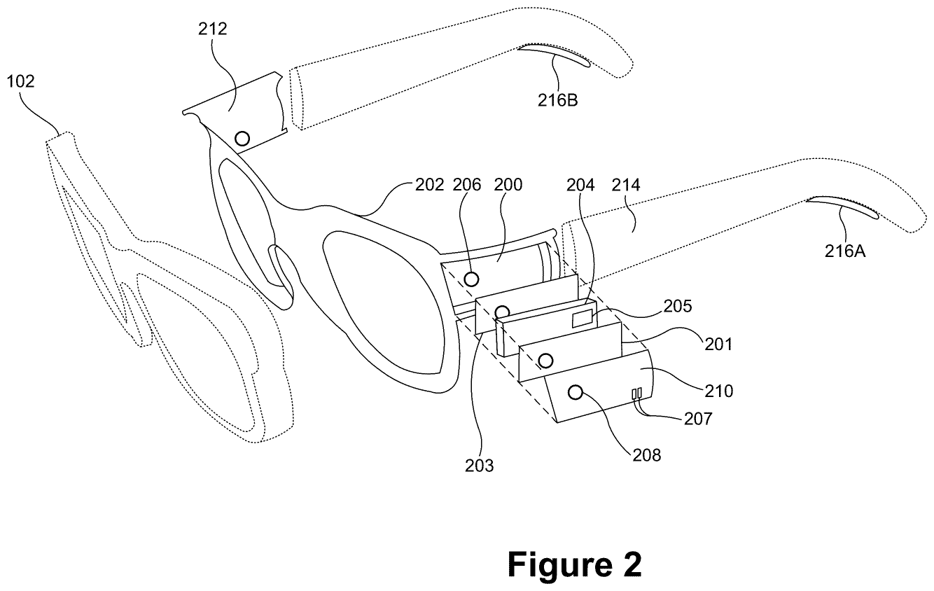

The electronics-holding frame plate 102 is coupled to printed circuit board 108 that is configured to be the main circuit board for the augmented-reality headset. Printed circuit board (PCB) 108 can be configured to be a shape that conforms to the shape of the nose bridge portion 104 of the electronics-holding frame plate 102, thereby maximizing the available space in the electronics-holding frame plate 102. In some embodiments, the printed circuit board includes one or more processors configured to control the plurality of electronic components coupled with the electronics-holding frame plate 102. In some embodiments, the printed circuit board is configured to control one or more additional electronic components (see FIG. 2) located in the temple arms (e.g., the portion of the augmented-reality headset that rests on an ear of a user) and/or the protrusions 106A-106B. In some embodiments, the printed circuit board is coupled with at least one communications radio and antennas 107A and 107B (e.g., Bluetooth, Wi-Fi, cellular, etc.), a user controllable image/video capturing device 108, one or more simultaneous localisation and mapping (SLAM) cameras 110A-110D (110D occluded), an infrared illuminator 112, one or more microphones 113, projector assemblies 116A and 116B, one or more inertial measurement units 118, one or more LEDs for conveying information to another user (e.g., a privacy LED to indicate recording is in progress), one or more eye-tracking cameras 117A (occluded) and 117B, ribbon cables 109A and 109B, etc.

In some embodiments, the projector assemblies 116A and 116B are placed behind (i.e., closer to a wearer's face and the backplate portion 114), and in another embodiment the projector assemblies 116A and 116B are placed in front (i.e., further from a wearer's face and further from the backplate portion 114).

In some embodiments, some of the plurality of electronic components are also structural components, such that they increase the rigidity of the electronics-holding frame plate 102 when coupled with the electronics-holding frame plate 102. For example, the communications radio and antenna 107A and 107B are placed at an exterior portion of the frame and provide structural support for the electronics-holding plate 102. In some embodiments, the communications radio and antenna 107A and 107B include portions that are overmolded onto the electronics-holding plate 102.

While certain electronic components are described as being coupled with the electronics-holding frame plate, it is conceivable that another augmented-reality headset could include any subset of these electronic components or place the electronic components in different locations of the augmented-reality headset. In addition, while some electronic components are described as being attached to the electronic-holding frame plate for case of manufacturing, it is understood that some of these electronic components can be mounted elsewhere in the augmented-reality headset, including the backplate portion 114, the protrusions 106A-106B, and/or the temple arms (explained above).

In some embodiments, the electronic components can be entirely attached to backplate portion 114 instead of the electronics-holding plate 102. In this embodiment, the electronics-holding plate 102 and the backplate portion 114 can have different thickness to accommodate the lack of electronic components and the addition of electronic components, respectively.

The electronics-holding frame plate 102 also includes a first set of waveguides (e.g., lenses capable of displaying an augmented reality on them that is projected via display projector assemblies 116A and 116B) that includes waveguides 122A and 122B corresponding to each eye of a wearer. In some embodiments, the waveguides 122A and 122B are coupled together and include positioning guide that aligns the waveguide 122A and 122B with the electronics-holding frame plate 102. In some embodiments, the electronics-holding frame plate 102 includes one or more cutouts 126 that is configured to receive the positioning guide. In some embodiments, the waveguide assembly is coupled to the electronics-holding frame plate 102 via one or more of clips, adhesive, and/or press-fittings. In some embodiments, the waveguide assembly is coupled to the electronics-holding frame plate 102 by being sandwiched between front cover 120 and the electronics-holding frame plate 102. In some embodiments, the first set of waveguide 122A and 122B are configured to be coupled to the PCB 108 and the PCB 108 is configured to control a dimming function (e.g., tinting to control translucency automatically from data received from an ambient light sensor) of waveguides 122A and 122B so that an augmented reality or virtual reality can be displayed in bright conditions (e.g., outside in sunlight). In some embodiments, the waveguide 122A is electrically coupled to waveguide 122B via a flexible interconnect 123, which is also coupled to the PCB.

In addition to the electronic components coupled, numerous non-powered components are coupled with the electronics-holding frame plate 102. In some embodiments, the non-powered components include a front cover 120 that is placed over an environment-facing portion of the electronics-holding frame plate 102 and is configured to act as a shield to protect one or more internal components (e.g., waveguide lenses) and is also configured to act as an aperture for at least one of user controllable image/video capturing device 108, one or more SLAM cameras 110, and/or an infrared illuminator 112. In some embodiments, the front cover 120 is user removable and allows for a user to select different front covers with different cosmetic designs. In some embodiments, the front cover 120 is secured in place using one or more of magnets, adhesives, or clips, or pressure fit into place (e.g., illustrated by indentation 104 located on the electronics-holding frame plate 102). In some embodiments, the front cover is constructed of two separate components, i.e., one for each side of the frame.

The electronics-holding frame plate 102 is coupled with at least two front bumpers (front bumpers 126A and 126B) that are configured to serve multiple functions. The first function of the front bumpers is to act as a shock absorber for waveguides 122A and 122B that are placed between the electronics-holding frame plate 102 and backplate portion 114. The second function of the front bumpers is to function as a blackout curtain (e.g., an industrial design consideration) so that when a wearer of the augmented-reality headset has donned the augmented-reality headset, the wearer is not able to see the plurality of components and the plurality of electronic components placed around the perimeter of first and second waveguides. In some embodiments, the two front bumpers 126A and 126B are made of a non-reflective material, thereby ensuring there are no reflections from the bumpers on the waveguides 122A and 122B. In some embodiments, the two front bumpers are coupled to the electronics-holding frame plate 102 via an adhesive and/or coupled by being sandwiched between the electronics-holding frame plate 102 and the backplate portion 114. In some embodiments, the waveguides 122A and 122B are further cushioned by rear bumpers 130A and 130B. In some embodiments, rear bumpers 130A and 130B are smaller (e.g., less thick) than front bumpers 126A and 126B as the front bumpers have the additional function of covering the cavity of the electronics-holding frame plate 102. In some embodiments, the waveguides are secured in place by both the front and rear bumpers.

FIG. 1 also shows that a second set of lenses, lenses 128A and 128B, can also be configured to be waveguides. In some embodiments, the lenses 128A and 128B are configured to tint when an electrical current is applied to them, in the same manner that waveguides 122A and 122B can be configured to do so.

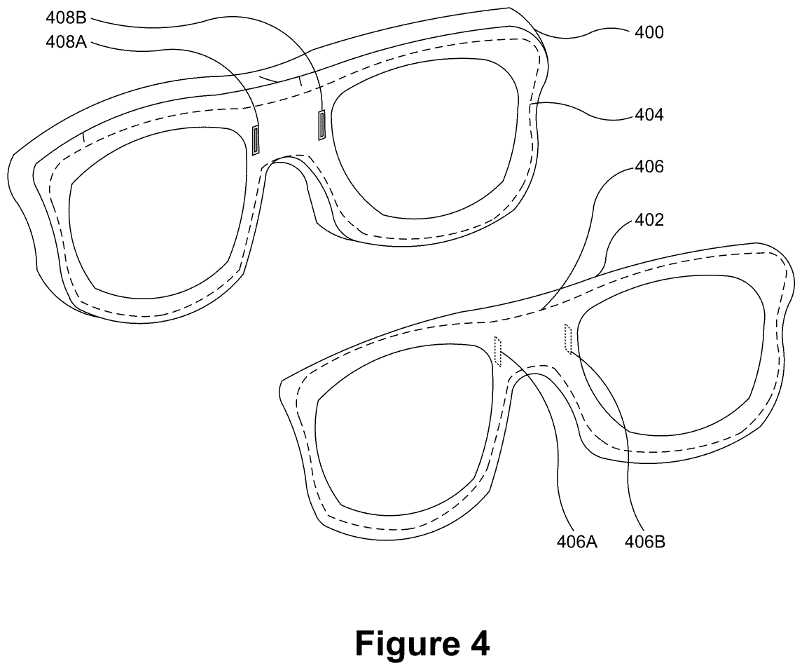

To close out the components described above, a backplate portion 114 is coupled with the electronics-holding frame plate 102. The backplate portion 114 is coupled to the electronics-holding frame plate 102 at locations at which the backplate portion 114 interfaces with the electronics-holding frame plate 102 (e.g., shut-off ledges on both the backplate portion 114 interface with the electronics-holding frame plate 102). In some embodiments, the shut-off ledges are configured to allow a common ground to be shared (described in detail in reference to FIG. 4). In some embodiments, a coating is removed at locations where the backplate portion 114 interfaces with the electronics-holding frame plate 102 to allow for a common ground to be produced. In some embodiments, the backplate portion 114 is configured to couple with the electronics-holding frame plate 102 via a tongue groove attachment.

The backplate portion 114 also has a third set of lenses, lenses 132A and 132B, which can be configured to be waveguides in some embodiments. The lenses 132A and 132B are each configured to be coupled with a backside of the backplate portion 114 (i.e., not sandwiched between the backplate portion 114 and the electronics-holding frame plate 102).

In some embodiments, the third set of lenses is one or more of press fit into place, adhered into place, screwed/bolted into place, etc. In some embodiments, the lenses 132A and 132B can also be configured to be dimming to control translucency, as described above in reference to the other lenses and waveguides.

FIG. 1 also illustrates that nose pads 134A and 134B are removable and are configured to couple with a bridge of the augmented-reality headset 100. The nose pads 134A-134B can be swapped out to adjust for varying facial structures of the user.

FIG. 2 shows another embodiment in which the backplate portion includes at least one recessed-side region that is configured to house one or more electronic components, in accordance with some embodiments.

The recessed-side region 200 (also referred to herein as an “intermediary portion” or “protrusion”) of backplate portion 202 (also described in part as backplate portion 114 in FIG. 1) is configured to include one or more additional electronic components comprising: flexible printed circuit board 204, a temperature sensor 205, one or more eye-tracking camera(s) 206, one or more side SLAM camera(s) 208, etc. The one or more additional electronic components can be secured in place by a side cover 210 that closes out the recessed-side region 200, such that the one or more additional electronic components are encapsulated. In some embodiments, the recessed-side region 200 includes a first inner structure 201 that is configured to partially secure the SLAM camera within the intermediary portion 200, and a second inner structure 203 that is configured to partially secure the eye-tracking camera 206 within the intermediary portion 200. In some embodiments, the intermediary portion can include charging contacts 207 (e.g., placed on an exterior surface of the side cover 210). In some embodiments, components are placed in the intermediary portion to improve weight balance of the augmented-reality headset when donned by a user.

While one recessed region 200 is discussed, the same or similar setup can be placed on the opposite side 212 of the backplate portion (e.g., another flexible printed circuit board, another one or more eye-tracking camera(s), and another one or more side SLAM camera(s), are included on the opposite side 212 of the backplate portion 202). In some embodiments, the recessed region 200 includes one or more stiffening structures that improve rigidity of the augmented-reality headset when assembled. In some embodiments, the stiffening structure is configured to also hold some of the additional electronic components. In some embodiments, the side-recessed region 200 is configured to hold a hinge assembly (not pictured), where the hinge assembly is configured to be coupled with a temple arm 214 (dashed).

FIG. 2 also shows that the temple arm 214 includes an ear pad 216A that is configured to be user removable. The ear pad 216A can be swapped out to adjust for varying facial structures of the user (e.g., ears of different heights can require different-sized ear pads for each ear to keep the headset level). A corresponding earpad 216B is shown on the other temple arm.

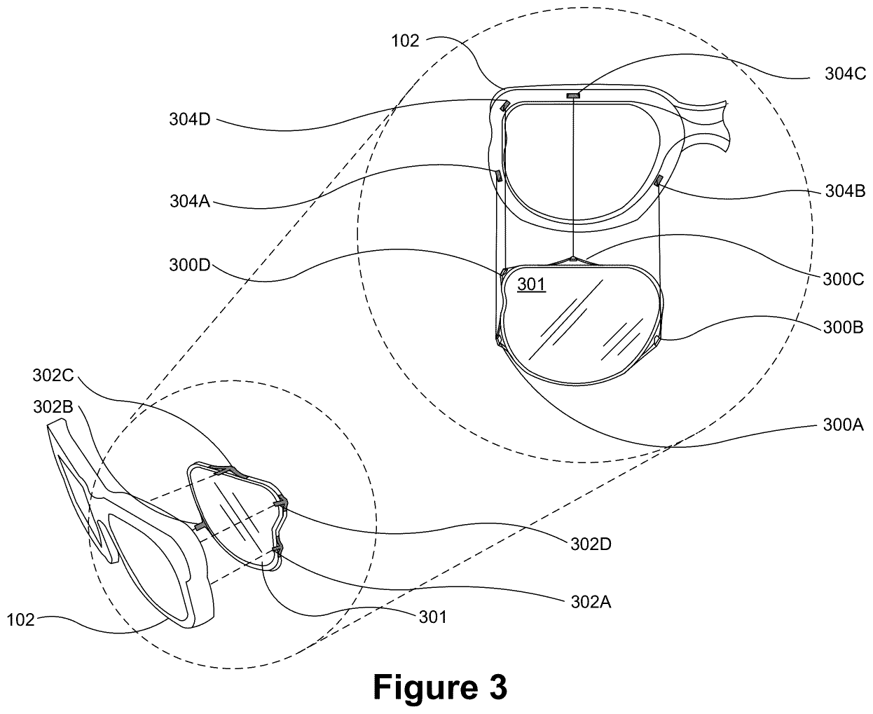

FIG. 3 illustrates how a plurality of flexures (300A, 300B, 300C, and 300D) that are coupled with a lens or waveguide (e.g., waveguide 301, which corresponds to waveguide 122A in FIG. 1) interface with electronics-holding frame plate 102, in accordance with some embodiments. The plurality of flexures are configured to (i) place the display (e.g., waveguide) within the electronics-holding frame plate 102 and (ii) dampen vibrations and damage due to movement and drops, respectively. In some embodiments, the flexures (300A, 300B, 300C, and 300D) are made of a material that is configured to flex and act as a spring (e.g., a leaf spring). In some embodiments, other springs can be utilized, such as coil springs, torsion springs, etc. The flexures also include tabs (302A, 302B, 302C, and 302D) that are configured to be inserted into respective troughs (304A, 304B, 304C, and 304D) located on the electronics holding frame plate 102. In some embodiments, the troughs are configured to contain glue or tape that allows for the tabs to be held in place. In some embodiments, the tabs can include a mechanical feature (e.g., a clip, bolt, etc.) that keeps the tabs secured to the electronics holding frame plate 102. In some embodiments, the glue can act as a damper, creating a spring damper combination when coupled (e.g., bonded) with the flexures.

FIG. 4 illustrates a shut-off ledges interface that is configured to ensure the electronics-holding frame plate 400 and the backplate portion 402 share a common ground, in accordance with some embodiments. A common ground ensures that any electrical components located in the electronics-holding frame plate 400, the backplate portion 402, and the temple arms (not pictured) all share a common ground that allows for the reference point for all voltages in the circuit to be the same, which can reduce noise in the electrical system. FIG. 4 illustrates that the common ground is created by having a shut-off ledge 404 (e.g., a mating surface) on the electronics-holding plate 400 in contact with another shut-off ledge 406 (e.g., another mating surface) of the backplate portion 402. In some embodiments, the shut-off ledge 404 and the other shut-off ledge 406 are treated to ensure an electrical pathway is created (e.g., machining the surface to expose an untreated surface (i.e., a coating-less surface when the electronics-holding frame plate 400 and the backplate portion 402 are constructed of an electrically conductive material) applying a conductive coating, or coupling a conductive material).

FIG. 4 also shows an example tongue-in-groove system for connecting the electronics-holding frame plate 400 and the backplate portion 402. The tongues are indicated by 406A and 406B on the backplate portion (dashed to indicate it is occluded in this view), and the groove is indicated by 408A and 408B, where the tongues 406A and 406B are configured to be inserted into the grooves 408A and 408B. In some embodiments, the tongue and groove can be continuous around the perimeters of the electronics-holding frame plate 400 and the backplate portion 402. In some embodiments, the groove can include a glue well to ensure that the tongue remains inserted in the groove. In some embodiments, the tongue and groove can also act as a form of a dust- and water-resistant/repellant barrier, ensuring that the electrical components are not damaged.

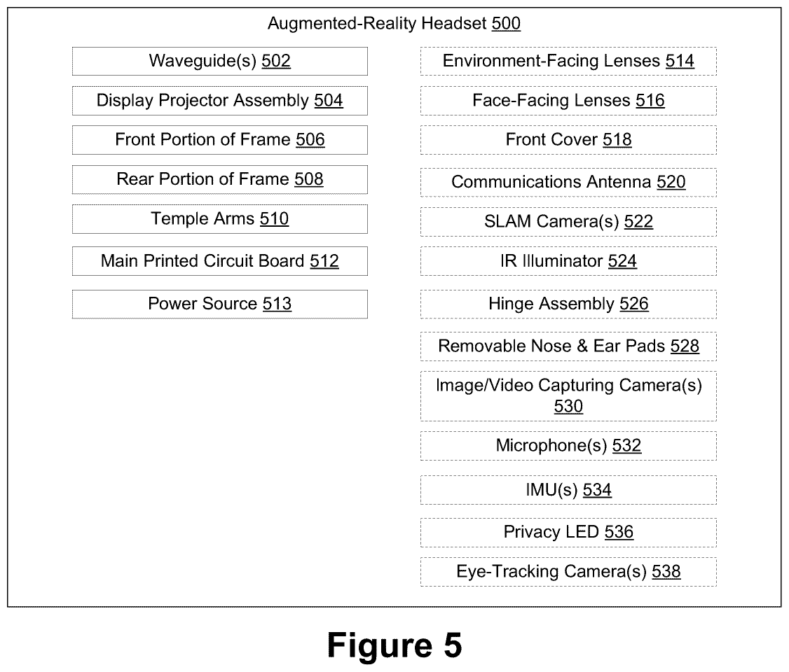

FIG. 5 illustrates a non-comprehensive list of components (electrical and non-electrical) that can be configured to be used in an augmented-reality headset. Some components described herein are optional and are illustrated as being optional by a dashed box surrounding the component in FIG. 5.

FIG. 5 illustrates a brief list of components that are essential for some of the operations of the augmented reality headset. In this example, augmented-reality headset 500, the augmented-reality headset comprises waveguides 502 (e.g., waveguides 122A and 122B in FIG. 1), a display projector assembly or assemblies 504 (e.g., a display and/or a display projector assemblies 116A and 116B in FIG. 1), a front portion of frame 506 (e.g., electronics-holding frame plate 102), a rear portion of frame 508 (e.g., backplate portion 114 in FIG. 1), temple arms 510 (e.g., temple arm 214 in FIG. 2), a main printed circuit board 512 (e.g., PCB 108 in FIG. 1), and a power source 513 (e.g., a battery). While the front portion of frame 506 is referenced as being the electronics-holding frame plate, and the rear portion of the frame 508 is referenced as being the backplate portion, it is conceivable that the front portion of frame 506 acts as a backplate and the rear portion of the frame 508 is configured to house the electronic components (e.g., the electronic components are coupled to the frame portion closest to the wearer's face when donned).

FIG. 5 also illustrates a non-comprehensive list of a plurality of components that can optionally be included in the augmented-reality headset either alone or in combination. For example, augmented-reality headset 500 can include environment-facing lenses 514 (e.g., lenses 128A and 128B in FIG. 1), face-facing lenses 516 (e.g., lenses 132A and 132B in FIG. 1), front covers 518 (e.g., a front cover 120), communications antenna 520 (e.g., communications radio and antenna 107A and 107B in FIG. 1), SLAM camera(s) 522 (e.g., SLAM cameras 110A-110D in FIG. 1 and SLAM camera 208 in FIG. 2), infrared (IR) illuminator 524 (e.g., infrared illuminator 112 in FIG. 1), a hinge assembly 526 (e.g., described in reference to FIG. 2), removable nose and ear pads 528 (e.g., nose pads 134A and 134B shown in FIG. 1, and ear pads 216A and 216B shown in FIG. 2), image/video capturing camera(s) 530 (e.g., image/video capturing device 108 in FIG. 1), microphone(s) 532 (e.g., one or more microphones 113 shown in FIG. 1), IMU(s) 534 (e.g., one or more inertial measurement units 118 shown in FIG. 1), privacy LED 536 (e.g., an outward-facing LED indicating whether a camera is recording or not), and eye-tracking camera(s) 538 (e.g., one or more eye-tracking cameras 117A (occluded) and 117B shown in FIG. 1 and one or more eye-tracking camera(s) 206 shown in FIG. 2).
(A1) In accordance with some embodiments, an augmented-reality headset (e.g., an augmented-reality headset, as shown in FIGS. 1-4 and 7A, is configured to display an extended reality, including a mixed reality, a virtual reality, etc.), comprises a data communications antenna (e.g., at least one communications radio and antennas 107A and 107B shown in FIG. 1 are shown as being located on a bottom portion of the electronics-holding frame plate 102). The augmented-reality headset includes a projector (e.g., a projector, such as display projector assemblies 116A and 116B shown in FIG. 1, which are configured to transmit light to a waveguide) and a display (e.g., a waveguide (e.g., waveguides 122A and 122B shown in FIG. 1), and/or a group of lenses and waveguides (e.g., lenses 128A and 128B, lenses 132A and 132B, and/or waveguides 122A and 122B) as shown in FIG. 1). The head-wearable device also includes a printed circuit board (PCB) for conveying data to and from the data communications antenna and the projector (e.g., printed circuit board 108 as shown in FIG. 1). The head-wearable device also includes a plurality of bumpers (e.g., front bumpers 126A and 126B, and rear bumpers 130A and 130B as shown in FIG. 1). An electronics-holding frame plate is also coupled to at least the PCB and the data communications antenna (e.g., electronics-holding frame plate 102 shown in FIGS. 1-3, and electronics-holding frame plate 400 shown in FIG. 4). In some embodiments, the PCB is positioned and resides within a cavity of the electronics-holding frame plate (e.g., the PCB is described as being positioned and residing within a cavity of the electronics-holding frame plate 102 in FIG. 1). In some embodiments, the data communications antenna partially resides within the cavity of the electronics-holding frame plate such that a portion of the data communications antenna is exposed to an external environment (e.g., FIG. 1 shows the communications radio and antennas 107A and 107B being placed flush or substantially flush with the underside of the electronics holding frame plate 102, where at least a portion of communications radio and antennas 107A and 107B is located within the cavity of the electronics-holding frame plate 102). In some embodiments, a portion of the data communications antenna is overmolded with the electronics-holding frame plate, and after overmolding, the data communications antenna and the electronics-holding frame plate are machined together to produce a seamless surface. The augmented-reality headset also includes a frame backplate (e.g., backplate portion 114 shown in FIG. 1, backplate portion 202 shown in FIG. 2, and backplate portion 402 shown in FIG. 4) configured to couple with the electronics-holding frame plate and enclose the data communications antenna, the projector, the display, the plurality of bumpers, and the PCB within the cavity of the electronics-holding frame plate. In some embodiments, a first bumper of the plurality of bumpers forms a first gap between the PCB and the display (e.g., FIG. 1 shows that front bumpers 126A and 126B have a first size (e.g., thickness), which defines a first gap between the PCB 108 and waveguides 122A and 122B), and a second bumper of the plurality of bumpers forms a second gap between the display and the frame backplate (e.g., FIG. 1 shows that rear bumpers 130A and 130B have a second size, as compared to the front bumpers 126A and 126B, which defines a second gap between the waveguides 122A and 122B and the backplate portion 114).

In some embodiments, the data communications antenna is positioned within a cutout portion of the electronics-holding frame plate, which allows the data communications antenna to be exposed to the external environment. By exposing the data communications antenna to the external environment it is able to operate as intended as it is not required to operate through a metallic surface of the electronics-holding frame plate.

An example augmented-reality headset comprises a two-piece frame, including a first frame portion and a second frame portion, and two intermediary protrusions extending from the corners of the two-piece frame, wherein each respective intermediary protrusion is configured to be hingably coupled with one of the two temple arms. The first frame portion includes an opening for receiving one or more lenses for presenting augmented-reality objects and a cavity for receiving: one or more electrical components, including a data-communication antenna, an augmented-reality presentation device, and a circuit board communicatively coupled with the data-communication antenna and the augmented-reality presentation device, wherein (i) the one or more electrical components are coupled at respective positions around a perimeter of the one or more lenses, (ii) the one or more electrical components are configured to be used in the presentation of the augmented-reality objects, and (iii) the one or more electrical components are not coupled with (e.g., mounted to) the second frame portion. The second frame portion is configured to secure the one or more lenses in place and also enclose the cavity defined by the first frame portion to thereby seal off the one or more electrical components from the external environment.
(A2) In some embodiments A1, the projector is configured to illuminate based on the data conveyed by the PCB such that light emitted by the projector is provided to the display and a representation of the data is presented to a user. In some embodiments, the projectors are configured to illuminate the display (e.g., waveguide) from a side of the display (e.g., a rear side of the display that is facing a wearer's face) and in other embodiments, the projectors are configured to illuminate the display from an opposite side of the display (e.g., a front side of the display that is facing an external environment).
(A3) In some embodiments of any of A1-A2, the plurality of bumpers separate the frame backplate from the data communications antenna, the projector, the display, and the PCB, such that the data communications antenna, the projector, the display, and the PCB do not contact the frame backplate (e.g., FIG. 1 shows that the front bumpers 126A and 126B in conjunction with the rear bumpers 130A and 130B are configured to isolate the waveguides 122A and 122B within the assembly, and are further configured to separate the backplate portion 114 from communications radio and antennas 107A and 107B, the display projector assemblies 116A and 116B, and the PCB 108) from the other components within. In some embodiments, the bumpers are pliable and are constructed of a rubber, silicone, etc., to increase damping of externally and internally applied forces/vibrations. In some embodiments, the bumpers are made of a composite material and use a rigid material, such as polycarbonate, acrylonitrile butadiene styrene (ABS), etc., to give shape to the bumper, along with a non-rigid material, such as rubber, silicone, etc., to provide damping for protecting the display (e.g., waveguide).
(A4) In some embodiments of any of A1-A3, the frame backplate includes a first side portion and a second side portion. In some embodiments, the augmented-reality headset further comprises a plurality of temple arms coupled with the first and second side portions of the frame backplate, and the plurality of temple arms are configured to affix the augmented-reality headset on the user's face when the augmented-reality headset is worn by the user. For example, FIG. 1 shows protrusions 106A-106B that are included with the backplate portion 114 and are configured to couple to temple arms (shown in FIG. 2) via a hinge (e.g., a spherical hinger configured to be adjustable along multiple axes).
(A5) In some embodiments of any of A1-A4, the first and second side portions include respective cavities, and the augmented-reality headset further comprises a first eye-tracking imaging device coupled within a cavity of the first side portion of the frame backplate (e.g., one or more eye-tracking camera(s) 206 shown in FIG. 2), and a second eye-tracking imaging device coupled within a cavity of the second side portion of the frame backplate (e.g., as described in reference to FIG. 2 the protrusions 106A-106B in FIG. 1 include mirrored components (e.g., both sides include an eye-tracking camera, etc.)). In some embodiments, the first and second eye-tracking imaging devices are positioned inward toward the electronics-holding frame plate (e.g., FIG. 2 shows that the eye-tracking cameras 206 shown in FIG. 2 are positioned inward toward the electronics-holding frame plate 102 (e.g., in the opposite direction than the location of a wearer's eyes)).
(A6) In some embodiments of A5, the augmented-reality headset further comprises an eye-tracking display coupled to an inner surface of the frame backplate, the inner surface of the frame backplate being a second surface of the frame backplate opposite of a first surface that is configured to couple with the electronics-holding frame plate. In some embodiments, the eye-tracking display is configured to work in conjunction with the first and second eye-tracking imaging devices to capture image data representative of reflections of the user's eye movements. For example, FIG. 2 illustrates eye-tracking cameras 206 shown in FIG. 2 are positioned inward toward the electronics-holding frame plate 102 (e.g., in the opposite direction than the location of a wearer's eyes). Eye movements are tracked through reflections off of a lens—image sensors that are housed within a side portion of the frame backplate and pointed toward the lens to capture the reflections. Each eye can have a dedicated lens and imaging device.
(A7) In some embodiments of any of A1-A6, the first and second side portions include respective cavities. The augmented-reality headset further comprises a first peripheral imaging device coupled within a cavity of the first side portion of the frame backplate (e.g., SLAM camera(s) 208 shown in FIG. 2, and SLAM camera 110B in FIG. 1), and a second peripheral imaging device coupled within a cavity of the second side portion of the frame backplate (e.g., as described in reference to FIG. 2, the protrusions 106A-106B in FIG. 1 include mirrored components (e.g., both sides include eye-tracking cameras, SLAM cameras, etc., and FIG. 1 also shows a SLAM camera 110D (occluded))). In some embodiments, the first and second peripheral imaging devices are positioned outward toward the external environment to allow for capture of image data representative of the external environment.
(A8) In some embodiments of any of A1-A7, the augmented-reality headset further comprises at least one front-facing imaging device, the at least one front-facing imaging device residing within the cavity of the electronics-holding frame plate and positioned outward toward the external environment to allow for capture of image data representative of the external environment. For example, FIG. 1 shows an image/video capturing device 108, and one or more simultaneous localisation and mapping (SLAM) cameras 110A-110D (110D occluded).
(A9) In some embodiments of any of A1-A8, the data communications antenna includes a molded body configured to fit within a cutout portion of the electronics-holding frame plate and form the airtight seal (e.g., at least one communications radio and antenna 107A and 107B shown in FIG. 1 is shown as being located on a bottom portion of the electronics-holding frame plate 102 and integrally formed with the electronics-holding frame plate 102).
(A10) In some embodiments of any of A1-A9, the electronics-holding frame plate and the frame backplate are magnesium-injection molded.
(A11) In some embodiments of any of A1-10, the electronics-holding frame plate and the frame backplate include respective shut-off ledges such that when the electronics-holding frame plate and the frame backplate are coupled, a common ground is formed. In some embodiments, a common ground is created by laser etching off a microarc oxidation (MAO) coating around perimeters (e.g., shut-off ledges) of both the electronics-holding frame plate and the frame backplate. For example, FIG. 4 illustrates shut-off ledges that are configured to ensure the electronics-holding frame plate 400 and the backplate portion 402 share a common ground.
(A12) In some embodiments of any of A1-11, the electronics-holding frame plate has a first rigidity and the frame backplate has a second rigidity, the second rigidity less than the first rigidity. The second rigidity renders the frame backplate portion semi-flexible such that the frame backplate can be molded to couple with the electronics-holding frame plate. For example, FIG. 1 illustrates that electronics-holding frame plate 102 is thicker than backplate portion 114, which in this example shows that the electronics-holding frame plate 102 is more rigid than backplate portion 114. In some embodiments, the opposite is true, and the backplate is more rigid than the electronics-holding frame plate.
(A13) In some embodiments of any of A1-12, the augmented-reality headset further comprises a user-detachable cosmetic portion configured to couple to an outer surface of the electronics-holding frame plate, the outer surface of the electronics-holding frame plate being a first surface of the electronics-holding frame plate opposite of a second surface that is configured to couple with the frame backplate. The detachable cosmetic portion is environment facing. In some embodiments, the user-detachable cosmetic portion is configured to couple to at least one of the plurality of temples. In some embodiments, the user-detachable cosmetic portion includes a plastic lens or surface that protects the one or more lenses and waveguides. For example, FIG. 1 illustrates a front cover 120 that is configured to be environment facing.
(A14) In some embodiments of any of A1-13, the augmented-reality headset further comprises a dimming display coupled to an outer surface of the electronics-holding frame plate, the outer surface of the electronics-holding frame plate being a first surface of the electronics-holding frame plate opposite of a second surface that is configured to couple with the frame backplate. In some embodiments, the dimming display is configured to actively dim light travelling through the dimming display. As discussed in reference to FIG. 1, any of the lenses 128A and 128B, lenses 132A and 132B, and waveguides 122A and 122B can be configured to dim based on light conditions and/or extended reality requirements (e.g., dimmer for VR as opposed to AR).
(A15) In some embodiments of any of A1-14, the electronics-holding frame plate and frame backplate include tongue-in-groove structures for coupling the electronics-holding frame plate and frame backplate together. For example, FIG. 4 shows example tongues 406A and 406B that are configured to be inserted into the grooves 408A and 408B and seal the electronics-holding frame plate 400 and the backplate portion 402.
(A16) In some embodiments of any of A1-15, the augmented-reality headset further comprises a removable nose pad configured to couple with a portion of the frame backplate such that the removable nose pad is located at a bridge of the augmented-reality headset and rests on a nose of the user when the augmented-reality headset is worn. In some embodiments, the nose pad is coupled to the augmented-reality headset via magnets, clips, snap fasteners, compression fit, etc. In some embodiments, the nose pads are configured to act as a wireless charging receiver, in addition to, or fully replacing, a USB-C charger located in one of the temple arms. For example, FIG. 1 shows that nose pads 134A and 134B are removable and are configured to couple with a bridge of the augmented-reality headset 100, specifically the electronics holding frame plate 102 in this example.
(A17) In some embodiments of any of A1-16, the augmented-reality headset further comprises a plurality of temple arms coupled to the frame backplate, wherein the plurality of temple arms is configured to affix the augmented-reality headset on the user's face when the augmented-reality headset is worn by the user (e.g., temple arm 214 shown in FIG. 2). Optionally, a plurality of removable ear pads configured to couple with a portion of the plurality of temple arms such that the plurality of removable ear pads is located adjacent to and rests on the user's ears when the augmented-reality headset is worn (e.g., an ear pad 216A that is configured to be user removable is shown in FIG. 2). In some embodiments, the plurality of removable ear pads is coupled to the augmented-reality headset via magnets, clips, snap fasteners, compression fit, etc. In some embodiments, the augmented-reality headset includes one or more sensors for detecting a position of the augmented-reality headset and provides a notification to the user that the augmented-reality headset is not appropriately positioned. The augmented-reality headset can provide suggestions for positioning the augmented-reality headset appropriately. For example, the augmented-reality headset can suggest different-sized nose pads and/or ear pads. Alternatively, in some embodiments, the augmented-reality headset can control a height of the nose pad and/or ear pads to appropriately position the augmented-reality headset.
(A18) In some embodiments of any of A1-17, the PCB is coupled to the electronics-holding frame plate using an adhesive, the adhesive providing drop resistance.
(A19) In some embodiments of any of A1-18, the electronics-holding frame plate and the frame backplate have a predetermined wall thickness.
(A20) In some embodiments of any of A1-19, the augmented-reality headset further comprising one or more sensors configured to detect a position of the augmented-reality headset with respect to the user's body (e.g., one or more inertial measurement units 118 are shown in FIG. 1). In some embodiments, the sensors include IMU sensors for don/doff detection. In some embodiments, the IMUs can be used to calibrate the different components of the augmented-reality headset. Additional components of the augmented-reality headset include one or more microphones and IR illuminators. The first and second peripheral imaging devices are at a fixed position to each other. The data communications antenna is a 5-7 GHz Wi-Fi antenna placed at the bottom of the frame and the PCB that controls the antenna is placed at a nose bridge location. In some embodiments, the augmented-reality headset includes blackout curtains in frame to block out view-distracting components. The blackout curtains are electrically transparent (e.g., to allow the communication component to transmit/receive).
(A21) In some embodiments of any of A1-A20, the augmented-reality headset of A1 is configured in accordance with any of A1-A20 and C1-C13, and D1-D13.
(B1) In accordance with some embodiments, an augmented-reality headset (e.g., augmented-reality headset 100 shown in FIG. 1), comprises one or more lenses (e.g., a lens that is configured to have a user interface projected onto it from a display projector assembly) within a housing of the artificial-reality headset, and at least one of the one or more lenses is configured to present an augmented reality user interface to a wearer of the artificial-reality headset (in some embodiments, the artificial-reality headset is further configured to display an immersive virtual reality) (e.g., waveguides 122A and 122B shown in FIG. 1 and waveguide 301 shown in FIG. 3). The augmented-reality headset includes one or more flexures (e.g., four flexures located around a perimeter of a lens) coupled to a lens of the one or more lenses (e.g., FIG. 3 illustrates how a plurality of flexures (300A, 300B, 300C, and 300D) that are coupled with waveguide 301), and each respective flexure of the one or more flexures is configured to (i) compress when a force (e.g., a drop shock force) is applied to the housing, thereby reducing a load received at the lens, and (ii) be coupled to the lens to orient the lens to have a predetermined orientation within the housing (e.g., FIG. 3 shows that the flexures also include tabs (302A, 302B, 302C, and 302D) that are configured to be inserted into respective troughs (304A, 304B, 304C, and 304D) located on the electronics holding frame plate 102). In some embodiments, the flexures are placed at locations statistically most likely to be first contact locations when the artificial-reality headset is dropped. The statistically most likely first contact locations during a drop can be determined based on common holding techniques and center of gravity of the artificial reality headset.
(B2) In some embodiments of B1, one of the one or more flexures is located on a top portion of one of the one or more lenses (e.g., flexure 300C shown in FIG. 3) (e.g., a location located near a brow location of a wearer). In some embodiments, another flexure of the one or more flexures is located on a bottom portion of the one or more lenses (e.g., close to a check of a wearer).
(B3) In some embodiments of any of B1-B2, one of the one or more flexures is located on a first side of one of the one or more lenses (e.g., near the user's nose), and the other flexure of the one or more flexures is located on a second side of the one or more lenses. The first side is opposite of the second side (e.g., near the user's temple). For example, FIG. 3 shows flexure 300A on an opposite side of the waveguide 301 than flexure 300B.
(B4) In some embodiments of any of B1-B3, an additional three flexures are located at different positions around the perimeter of the lens (e.g., waveguide). For example, FIG. 3 shows that flexures 300A-300D are placed around a perimeter of the waveguide 301.
(B5) In some embodiments of any of B1-B4, the lens of the one or more lenses is further oriented by at least one bumper that is configured to constrain the lens along an axis other than an axis constrained by the one or more flexures (e.g., front bumpers 126A and 126B and rear bumpers 130A and 130B further constrain the waveguides 122A and 122B, as shown in FIG. 1). In some embodiments, the bumper is made of a shock-absorbent material, such as a soft plastic, silicone, rubber, etc., to further dampen vibrations and reduce damage during a fall event.
(B6) In some embodiments of any of B1-B5, the bumper is configured to compress when another force, perpendicular to the force, is applied to the housing, thereby reducing the load received at the lens (e.g., along another axis) (e.g., front bumpers 126A and 126B and rear bumpers 130A and 130B are configured to compress to dampen forces acting on the waveguides 122A and 122B, as shown in FIG. 1).
(B7) In some embodiments of any of B1-B6, the lens of the one or more lenses is sandwiched between the at least one bumper and another bumper (e.g., constraining the lens in place). In some embodiments, the one bumper is of a different material than the other bumper. In some embodiments, the one bumper has a different shape than the other bumper. Front bumpers 126A and 126B and rear bumpers 130A and 130B sandwich the waveguides 122A and 122B, respectively, as shown in FIG. 1.
(B8) In some embodiments of any of B1-B7, the at least one bumper is in contact with a face-facing portion of the augmented-reality headset, and the other bumper is in contact (e.g., coupled via an adhesive) with an environment-facing portion of the artificial reality headset (e.g., FIG. 1 shows front bumpers 126A and 126B being in contact with the electronics holding frame plate 102 (environment-facing portion) and rear bumpers 130A and 130B are in contact with the backplate portion 114 (face-facing portion)).
(B9) In some embodiments of any of B1-B8, the at least one bumper is further configured to hide from the user's field of view of the one or more electrical components used to present augmented reality user interfaces to the user (e.g., front bumpers 126A and 126B are configured as blackout curtains (e.g., an industrial design consideration) so that when a wearer of the augmented-reality headset has donned the augmented-reality headset, the wearer is not able to see the plurality of components and the plurality of electronic components placed around the perimeter of first and second waveguides). In some embodiments, the bumper improves the industrial design of the headset by hiding mechanical features and electronics that can reflect light being displayed in the augmented reality or detract from the viewing experience in other capacities (e.g., distracting the user from the augmented reality).
(B10) In some embodiments of any of B1-B9, the flexure is positioned at a corner of the lens (e.g., top corner, bottom corner, etc.). For example, FIG. 3 illustrates that flexure 300D is placed in a corner of the waveguide 301. In some embodiments, the placement of the flexure correlates to the most probable impact location during a drop (e.g., the corner of the augmented-reality headset where the frame meets the temple arm).
(B11) In some embodiments of any of B1-B10, the one or more of the flexures are leaf springs (coil springs, torsion spring, etc.), further wherein each end of the leaf spring is coupled to the lens, and a center portion of the leaf spring is configured to contact a portion of the housing (e.g., a pad on the housing or in direct contact with the frame). In some embodiments, the leaf spring is always in contact with the portion of the housing. For example, the flexures shown in FIG. 3 are leaf springs.
(B12) In some embodiments of any of B1-B11, the bumper is coupled to the center portion of the leaf spring, thereby producing a spring (e.g., the leaf spring) and damper (e.g., the bumper) system to reduce vibrations of the one or more lenses. A spring and damper system is ideal in situations where movement of the wearer is great, as the spring and damper will eliminate vibrations and bring the assembly to a steady state sooner than a spring system alone. Front bumpers 126A and 126B and rear bumpers 130A and 130B sandwich the waveguides 122A and 122B, respectively, and act as dampers, as shown in FIG. 1.
(B13) In some embodiments of any of B1-B12, each of the flexures is coupled to the perimeter of the lens via a guide of a flexure being inserted into a glue pocket located within the housing. In some embodiments, the glue pockets can also act as a damper for the flexures. FIG. 3 shows that each flexure includes a protrusion that is configured to be inserted into respective glue wells of the electronics-holding frame plate 102.
(B14) In some embodiments of any of B1-B13, the one or more lenses within the housing include two sets of lens assemblies, wherein each lens assembly includes the lens, and two additional lenses that sandwich the lens within the housing. For example, FIG. 1 shows lenses 128A and 128B, lenses 132A and 132B, and waveguide 122A and 122B.
(B15) In some embodiments of any of B1-B14, one of the two additional lenses is clipped into the face-facing portion (e.g., lenses 132A and 132B), and the other one of the two additional lenses is glued into place on the environment-facing portion of the glasses frame (e.g., lenses 128A and 128B).
(B16) In some embodiments of any of B1-B15, the augmented-reality headset is configured in accordance with any of A1-A20, C1-C13, and D1-D14.
(C1) In accordance with some embodiments, an augmented-reality headset comprises a first lens (e.g., lenses 132A and 132B shown in FIG. 1) surrounded by a first bumper (e.g., rear bumpers 130A and 130B as shown in FIG. 1), and a waveguide (e.g., waveguides 122A and 122B as shown in FIG. 1) positioned in front of the first lens. The augmented-reality headset also comprises a second lens (e.g., lenses 128A and 128B shown in FIG. 1) surrounded by a second bumper (front bumpers 126A and 126B shown in FIG. 1), and a display projector assembly (e.g., display projector assemblies 116A and 116B shown in FIG. 1) configured to direct light onto the waveguide to create an augmented-reality experience for a wearer of the augmented-reality headset, the display projector assembly being positioned between the waveguide and the second lens (e.g., as illustrated in FIG. 1).
(C2) In some embodiments of C1, the first lens is configured to be closer to the wearer's face than the second lens (e.g., FIG. 1 illustrates that the first lenses 132A and 132B are closer to a wearer's face than lenses 128A and 128B).
(C3) In some embodiments of C1, the second lens is configured to be closer to the wearer's face than the first lens.
(C4) In some embodiments of any of C1-C3, the eye-tracking camera is configured to be positioned such that the eye-tracking camera is closer to the wearer's face than the first lens (e.g., FIG. 1 shows that the eye-tracking cameras 117A and 117B are configured to be closer to a wearer's face along at least one axis than the first lenses 132A and 132B).
(C5) In some embodiments of any of C1-C3, the eye-tracking camera is configured to be positioned such that the eye-tracking camera is closer to the wearer's face than the second lens (e.g., FIG. 1 shows that the eye-tracking cameras 117A and 117B are configured to be closer to a wearer's face along at least one axis than the second lenses 128A and 128B).
(C6) In some embodiments of any of C1-C5, the waveguide includes one or more flexures placed at respective locations around a perimeter of the waveguide, wherein the flexures are configured to reduce vibrations and impact forces from interfering with the augmented-reality experience (e.g., FIG. 3 shows a plurality of flexures 300A-300D configured to reduce vibrations and impact damage).
(C7) In some embodiments of any of C1-C6, the first lens (e.g., lenses 132A and 132B) is configured to change translucency (e.g., dim) to limit the amount of ambient light that reaches the waveguide.
(C8) In some embodiments of any of C1-C7, the second lens (e.g., lenses 128A and 128B) is configured to dim to limit the amount of ambient light that reaches the waveguide.
(C9) In some embodiments of any of C1-C8, at least one of the first bumper and the second bumper are configured to cover one or more electronic devices (including the display projector assembly) from being viewed when the augmented-reality headset is being worn by a wearer (e.g., front bumpers 126A and 126B are configured to cover one or more electronic and non-electronic components from being visible to the user while the augmented-reality headset is donned).
(C10) In some embodiments of C9, the first bumper and the second bumper are further configured to reduce vibrations and impact forces from interfering with the augmented-reality experience (e.g., front bumpers 126A and 126B, and rear bumpers 130A and 130B are further configured to reduce vibration and impact forces from interacting with the waveguides 122A and 122B).
(C11) In some embodiments of any of C1-C10, the first lens is closer to the waveguide than the second lens.
(C12) In some embodiments of any of C1-C10, the second lens is closer to the waveguide than the first lens.
(C13) In some embodiments of C1-C12, the augmented-reality headset is further configured in accordance with any of claims A1-A20, B1-B15, and D1-D13.
(D1) In accordance with some embodiments, an augmented-reality headset comprises an intermediary component attached to a glasses frame configured to house (e.g., protrusions 106A-106B shown in FIG. 1, and recessed side regions 200 shown in FIG. 2) a SLAM camera placed on a first side of the intermediary component (e.g., FIG. 2 illustrates one or more side SLAM camera(s) 208 facing away from a wearer's face), wherein the SLAM camera is configured to map a portion of an environment surrounding the augmented-reality headset. The intermediary component is also configured to house an eye-tracking camera located on a second side of the intermediary component, where the second side is opposite to the first side of the intermediary component, and the eye-tracking camera is configured to track one or both eyes of a wearer (e.g., one or more eye-tracking camera(s) 206 shown in FIG. 2 is opposite to the SLAM camera 208).
(D2) In some embodiments of D1, the augmented-reality headset further comprises a printed circuit board (e.g., a flexible printed circuit board) configured to at least partially couple the SLAM camera and the eye-tracking camera to one or more processing components located within the augmented-reality headset (e.g., printed circuit board 204 shown in FIG. 2).
(D3) In some embodiments of any of D1-D2, the augmented-reality headset further comprises a first inner structure portion configured to partially secure the SLAM camera within the intermediary component (e.g., first inner structure 201 shown in FIG. 2); and a second inner structure portion configured to partially secure the eye-tracking camera within the intermediary component (e.g., second inner structure 203 shown in FIG. 2).
(D4) In some embodiments of any of D1-D3, the intermediary portion is integrally formed with a glasses frame (e.g., FIG. 2 shows that the intermediary portion 200 is integrally formed with the backplate portion 202 of the augmented-reality glasses).
(D5) In some embodiments of any of D1-D4, the intermediary component further comprises a cover configured to cover the intermediary component, wherein the cover includes a window such that the SLAM camera can map a portion of an environment surrounding the augmented-reality headset (e.g., side cover 210 shown in FIG. 2).
(D6) In some embodiments of any of D1-D5, the augmented-reality headset of claim 49, wherein the intermediary portion partially contains a hinge configured to rotate a temple arm of the augmented-reality headset relative to a glasses frame of the augmented-reality headset (e.g., a hinge assembly is described in reference to FIG. 2).
(D7) In some embodiments of any of D1-D6, the intermediary portion includes one or more charging contacts for charging a battery of the augmented-reality headset (e.g., charging contacts 207 shown in FIG. 2).
(D8) In some embodiments of any of D1-D7, the intermediary portion includes a temperature sensor configured to measure a surface contact temperature of the intermediary portion (e.g., temperature sensor 205 shown in FIG. 2).
(D9) In some embodiments of any of D1-D8, the intermediary portions include one or more additional electronic components configured to assist at least partially in providing an augmented-reality experience (e.g., FIG. 2 shows a circuit board that includes one or more additional electronic components configured to assist at least partially in providing an augmented-reality experience).
(D10) In some embodiments of any of D1-D9, the augmented-reality headset further comprises another intermediary component attached opposite to the intermediary component. The other intermediary component includes another SLAM camera placed on a first side of the other intermediary component, and the SLAM camera is configured to map another portion of the environment surrounding the augmented-reality headset. The other intermediary component also includes another eye-tracking camera located on a second side of the other intermediary component, where the second side is opposite to the first side of the other intermediary component; and the eye-tracking camera is configured to track one or both eyes of the wearer. For example, FIG. 2 illustrates that a similar or same arrangement of components exists on the opposite side 212 of the backplate portion.
(D11) In some embodiments of any of D1-D10, the other intermediary component is configured to have features described in accordance with any of D1-D9.
(D12) In some embodiments of any of D1-D11, the intermediary component is configured to match a profile of a temple arm, where the temple arm is coupled to the intermediary component (e.g., FIG. 2 shows that the temple arm 214 matches a profile of the intermediary portion 200).
(D13) In some embodiments of any of D1-D12, the eye-tracking camera is configured to point away from an eye of a user (e.g., FIG. 2 shows that the eye-tracking camera 206 points away from an eye of a user).
(D14) In some embodiments of any of D1-D13, the augmented-reality headset is further configured in accordance with any of A1-A20, B1-B15, and C1-C13.
(E1) In accordance with some embodiments, a display projector assembly for an augmented-reality headset comprises an array of microLEDs, wherein the microLEDs of the array of microLEDs each have a largest dimension between 2-5 micrometers (e.g., red, blue, green microLED arrays). The display projector assembly includes one or more electronic components for controlling respective outputs of the array of microLEDs, and a lens holder that holds a collimator, wherein the collimator focuses an output of the array of microLEDs for projection onto a waveguide of the augmented-reality headset.
(E2) In some embodiments of E1, the display projector assembly is configured in accordance with any one of A1-D14.
(F1) In accordance with some embodiments, a display assembly has a first lens that includes a light emitter. The light emitter is configured to illuminate a portion of a user's eye for use in conjunction with an eye-tracking camera, and the eye-tracking camera is configured to monitor reflections of the portion of the user's eye on the first lens to detect eye gaze. The display assembly includes a first bumper separating the first lens from a waveguide, wherein: the first bumper isolates the waveguide from impacts, and the waveguide is configured is configured to project an image an image provided by a display projector assembly. The display assembly includes a second lens and a second bumper placed between the waveguide and the second lens, wherein the second bumper is configured to: (i) to cover surrounding electronics of an augmented-reality headset from view by the wearer, and (ii) isolates the waveguide from impacts. The display assembly includes a third bumper placed between the second bumper and the lens, wherein the first bumper isolates the waveguide from impacts.
(F2) In some embodiments of F1, the display assembly is configured in accordance with any one of A1-E2.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 700, a head-wearable device, an HIPD 900, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

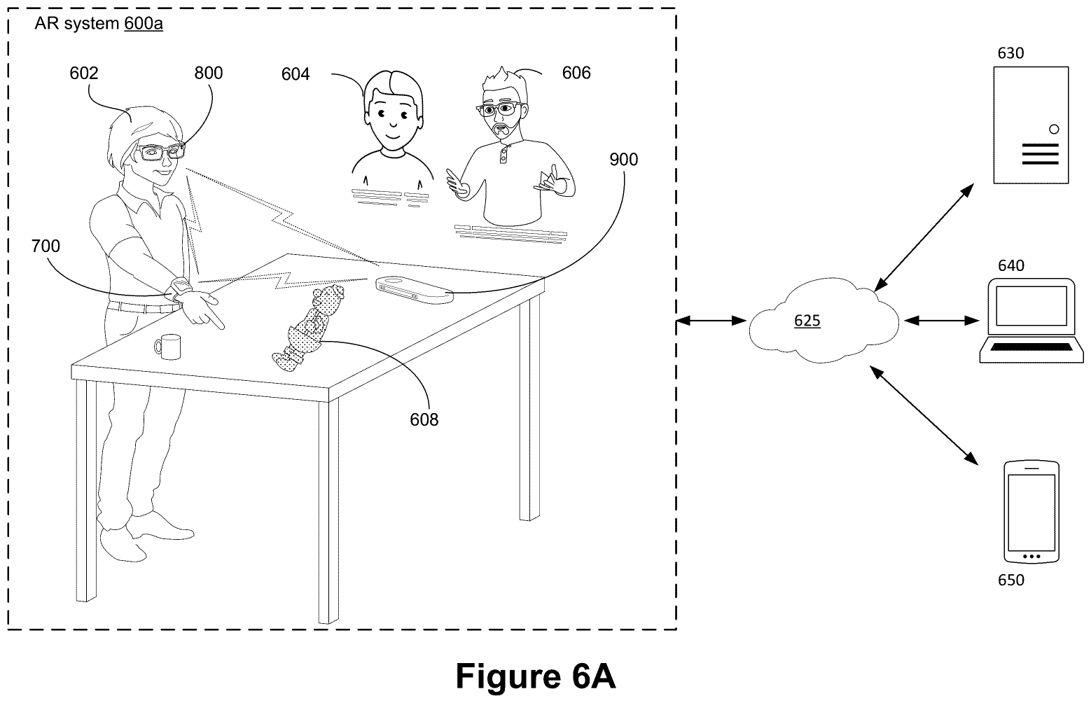

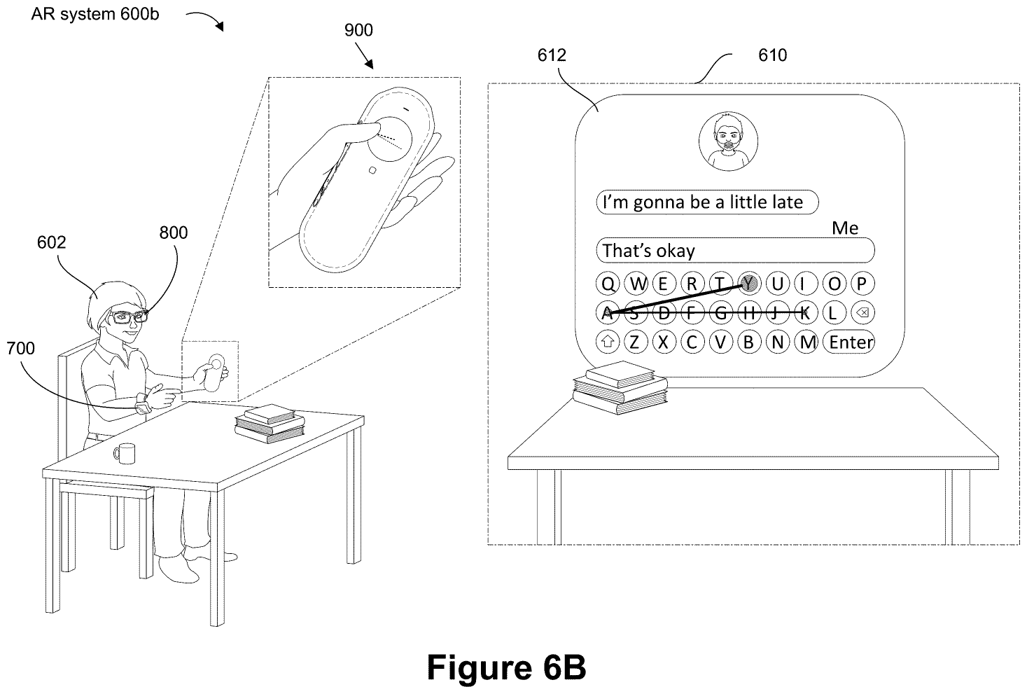

FIGS. 6A and 6B illustrate example artificial-reality systems, in accordance with some embodiments. FIG. 6A shows a first AR system 600a and first example user interactions using a wrist-wearable device 700, a head-wearable device (e.g., AR device 800), and/or a handheld intermediary processing device (HIPD) 900. FIG. 6B shows a second AR system 600b and second example user interactions using a wrist-wearable device 700, AR device 800, and/or an HIPD 900. As the skilled artisan will appreciate upon reading the descriptions provided herein, the above-example AR systems (described in detail below) can perform various functions and/or operations described above with reference to FIGS. 1-5.

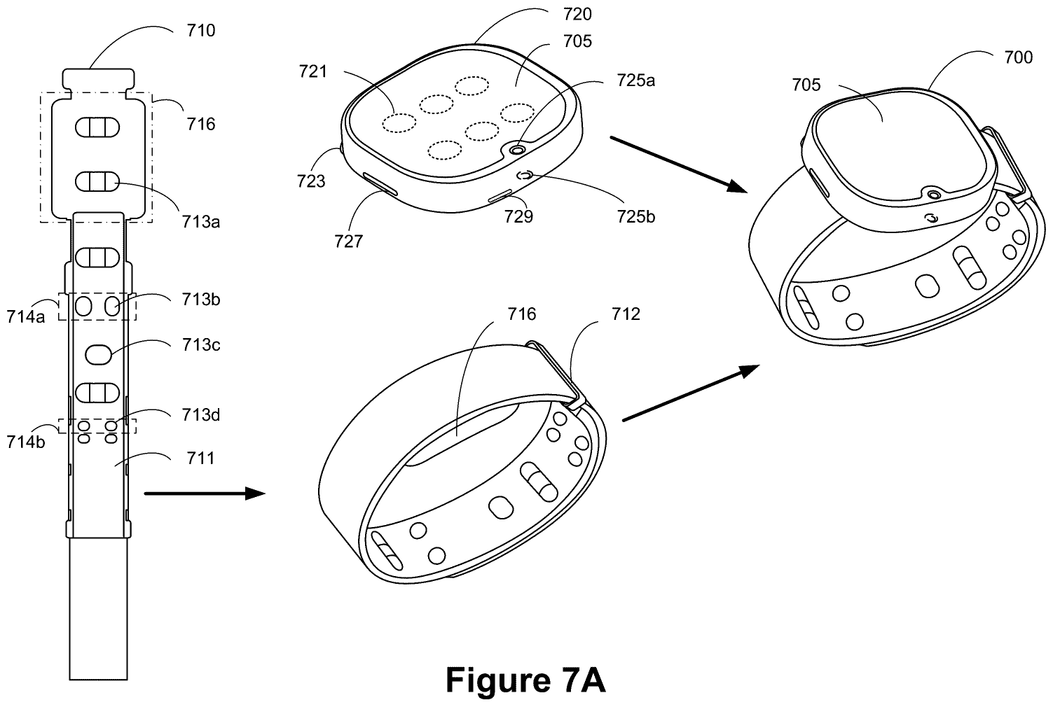

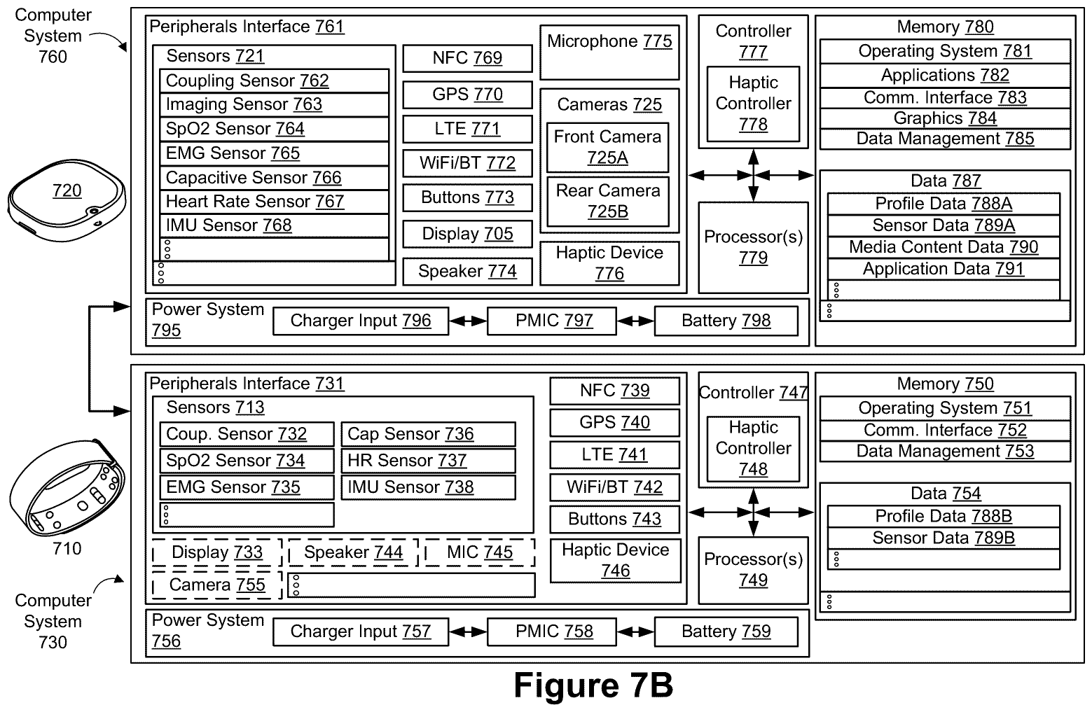

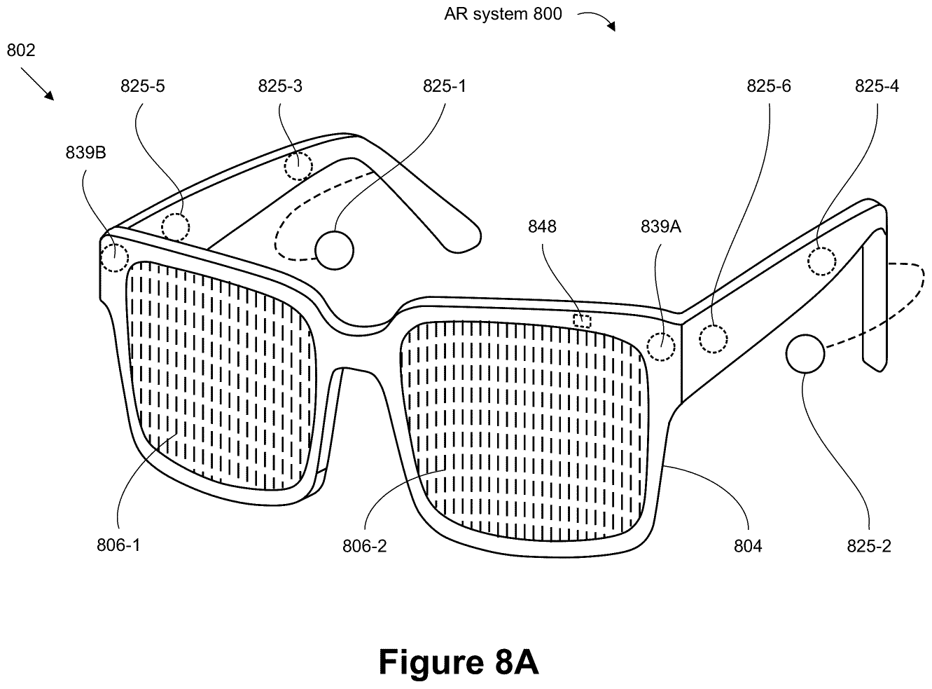

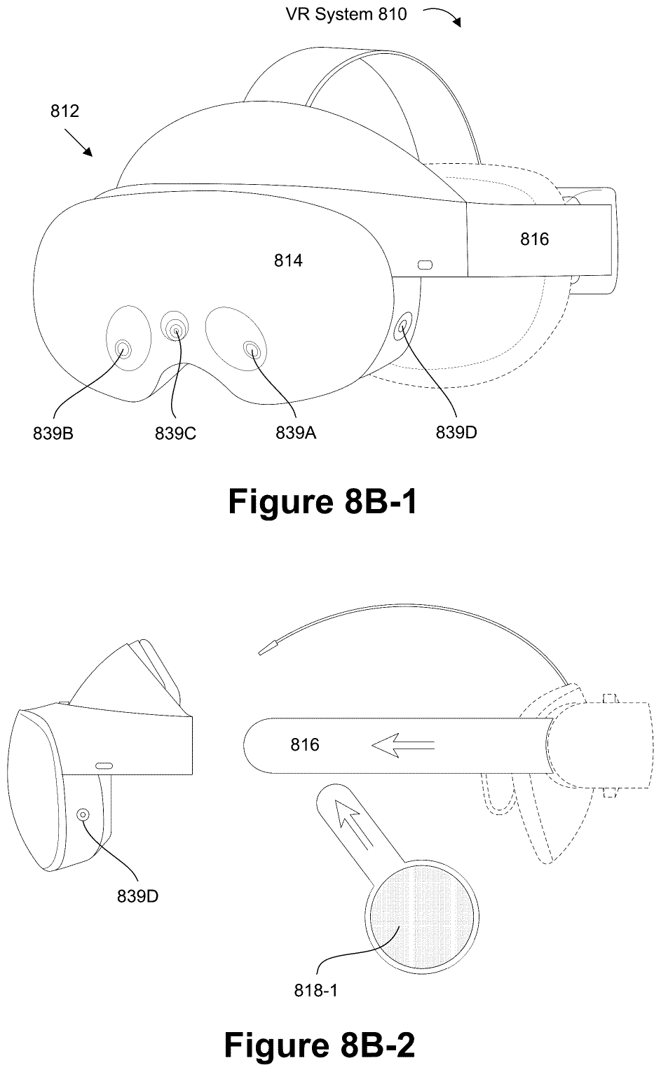

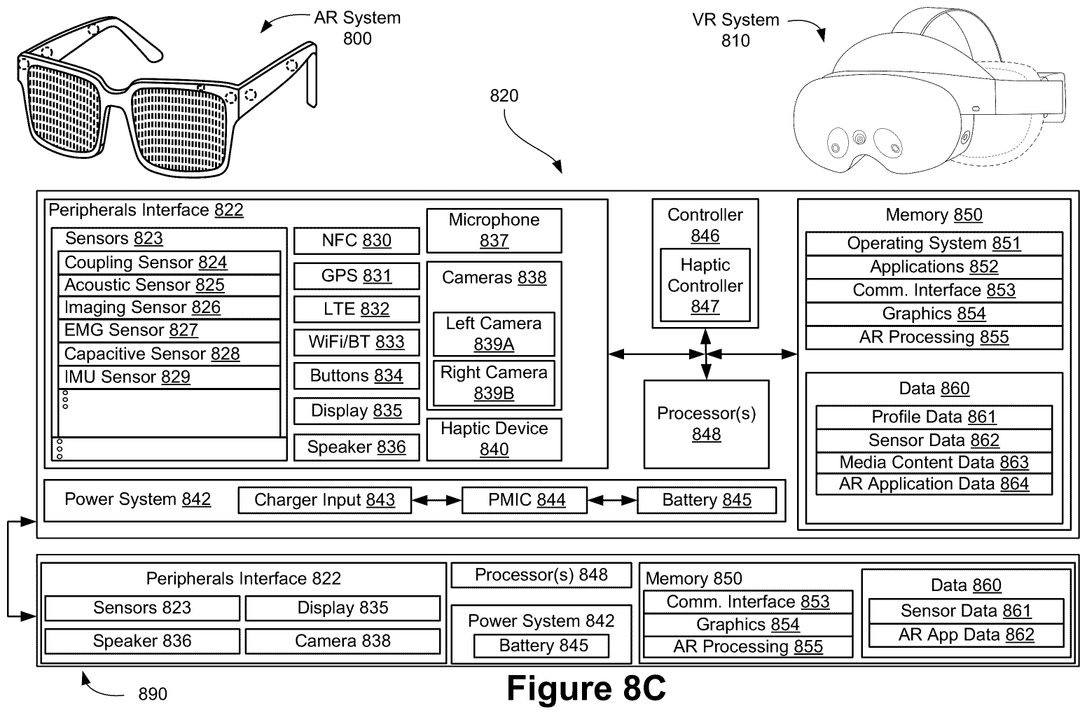

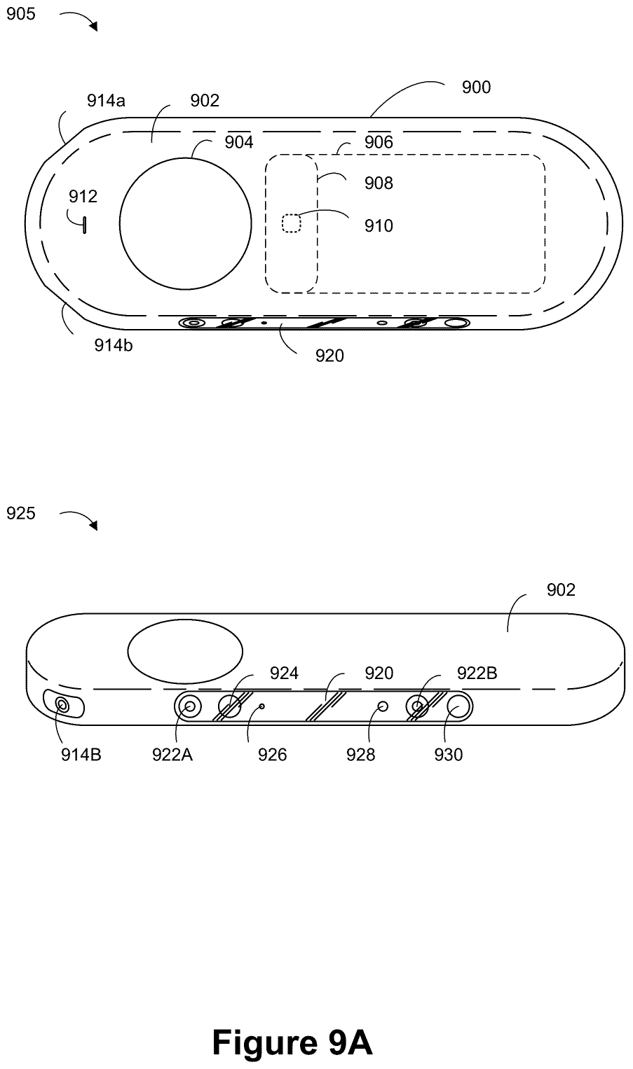

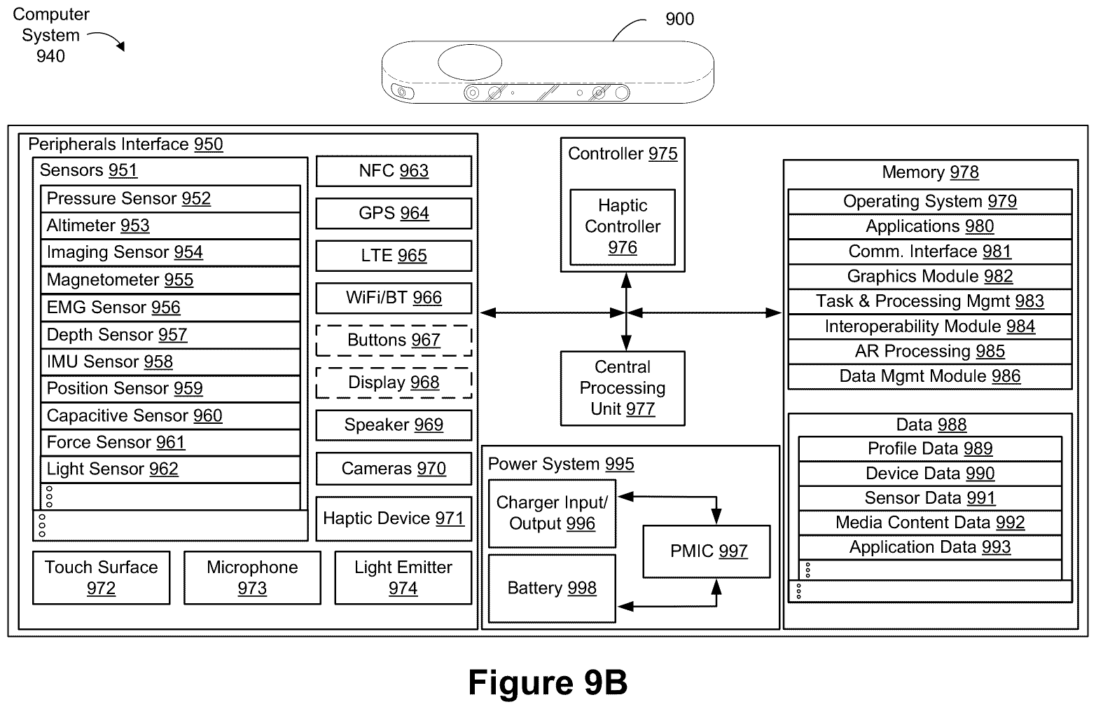

The wrist-wearable device 700 and its constituent components are described below in reference to FIGS. 7A-7B, the head-wearable devices and their constituent components are described below in reference to FIGS. 8A-8D, and the HIPD 900 and its constituent components are described below in reference to FIGS. 9A-9B. The wrist-wearable device 700, the head-wearable devices, and/or the HIPD 900 can communicatively couple via a network 625 (e.g., cellular, near field, Wi-Fi, personal area network, wireless LAN, etc.). Additionally, the wrist-wearable device 700, the head-wearable devices, and/or the HIPD 900 can also communicatively couple with one or more servers 630, computers 640 (e.g., laptops, computers, etc.), mobile devices 650 (e.g., smartphones, tablets, etc.), and/or other electronic devices via the network 625 (e.g., cellular, near field, Wi-Fi, personal area network, wireless LAN, etc.).

Turning to FIG. 6A, a user 602 is shown wearing the wrist-wearable device 700 and the AR device 800, and having the HIPD 900 on their desk. The wrist-wearable device 700, the AR device 800, and the HIPD 900 facilitate user interaction with an AR environment. In particular, as shown by the first AR system 600a, the wrist-wearable device 700, the AR device 800, and/or the HIPD 900 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 700, the AR device 800, and/or the HIPD 900.

The user 602 can use any of the wrist-wearable device 700, the AR device 800, and/or the HIPD 900 to provide user inputs. For example, the user 602 can perform one or more hand gestures that are detected by the wrist-wearable device 700 (e.g., using one or more EMG sensors and/or IMUs, described below in reference to FIGS. 7A-7B) and/or AR device 800 (e.g., using one or more image sensors or cameras, described below in reference to FIGS. 8A-8B) to provide a user input. Alternatively, or additionally, the user 602 can provide a user input via one or more touch surfaces of the wrist-wearable device 700, the AR device 800, and/or the HIPD 900, and/or voice commands captured by a microphone of the wrist-wearable device 700, the AR device 800, and/or the HIPD 900. In some embodiments, the wrist-wearable device 700, the AR device 800, and/or the HIPD 900 include a digital assistant to help the user in providing a user input (e.g., completing a sequence of operations, suggesting different operations or commands, providing reminders, confirming a command). In some embodiments, the user 602 can provide a user input via one or more facial gestures and/or facial expressions. For example, cameras of the wrist-wearable device 700, the AR device 800, and/or the HIPD 900 can track the user 602's eyes for navigating a user interface.

The wrist-wearable device 700, the AR device 800, and/or the HIPD 900 can operate alone or in conjunction to allow the user 602 to interact with the AR environment. In some embodiments, the HIPD 900 is configured to operate as a central hub or control center for the wrist-wearable device 700, the AR device 800, and/or another communicatively coupled device. For example, the user 602 can provide an input to interact with the AR environment at any of the wrist-wearable device 700, the AR device 800, and/or the HIPD 900, and the HIPD 900 can identify one or more back-end and front-end tasks to cause the performance of the requested interaction and distribute instructions to cause the performance of the one or more back-end and front-end tasks at the wrist-wearable device 700, the AR device 800, and/or the HIPD 900. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 9A-9B, the HIPD 900 can perform the back-end tasks and provide the wrist-wearable device 700 and/or the AR device 800 operational data corresponding to the performed back-end tasks such that the wrist-wearable device 700 and/or the AR device 800 can perform the front-end tasks. In this way, the HIPD 900, which has more computational resources and greater thermal headroom than the wrist-wearable device 700 and/or the AR device 800, performs computationally intensive tasks and reduces the computer resource utilization and/or power usage of the wrist-wearable device 700 and/or the AR device 800.

In the example shown by the first AR system 600a, the HIPD 900 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 900 performs back-end tasks for processing and/or rendering image data (and other data) associated with the AR video call and provides operational data associated with the performed back-end tasks to the AR device 800 such that the AR device 800 performs front-end tasks for presenting the AR video call (e.g., presenting the avatar 604 and the digital representation of the contact 606).

In some embodiments, the HIPD 900 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 900. In particular, the HIPD 900 and the AR device 800 operate in conjunction to determine a location for presenting the avatar 604 and the digital representation of the contact 606. In some embodiments, information can be presented within a predetermined distance from the HIPD 900 (e.g., within five meters). For example, as shown in the first AR system 600a, virtual object 608 is presented on the desk some distance from the HIPD 900. Similar to the above example, the HIPD 900 and the AR device 800 can operate in conjunction to determine a location for presenting the virtual object 608. Alternatively, in some embodiments, presentation of information is not bound by the HIPD 900. More specifically, the avatar 604, the digital representation of the contact 606, and the virtual object 608 do not have to be presented within a predetermined distance of the HIPD 900.

User inputs provided at the wrist-wearable device 700, the AR device 800, and/or the HIPD 900 are coordinated such that the user can use any device to initiate, continue, and/or complete an operation. For example, the user 602 can provide a user input to the AR device 800 to cause the AR device 800 to present the virtual object 608 and, while the virtual object 608 is presented by the AR device 800, the user 602 can provide one or more hand gestures via the wrist-wearable device 700 to interact and/or manipulate the virtual object 608.

FIG. 6B shows the user 602 wearing the wrist-wearable device 700 and the AR device 800, and holding the HIPD 900. In the second AR system 600b, the wrist-wearable device 700, the AR device 800, and/or the HIPD 900 are used to receive and/or provide one or more messages to a contact of the user 602. In particular, the wrist-wearable device 700, the AR device 800, and/or the HIPD 900 detect and coordinate one or more user inputs to initiate a messaging application and prepare a response to a received message via the messaging application.

In some embodiments, the user 602 initiates, via a user input, an application on the wrist-wearable device 700, the AR device 800, and/or the HIPD 900 that causes the application to initiate on at least one device. For example, in the second AR system 600b the user 602 performs a hand gesture associated with a command for initiating a messaging application (represented by messaging user interface 612); the wrist-wearable device 700 detects the hand gesture; and, based on a determination that the user 602 is wearing AR device 800, causes the AR device 800 to present a messaging user interface 612 of the messaging application. The AR device 800 can present the messaging user interface 612 to the user 602 via its display (e.g., as shown by user 602's field of view 610). In some embodiments, the application is initiated and can be run on the device (e.g., the wrist-wearable device 700, the AR device 800, and/or the HIPD 900) that detects the user input to initiate the application, and the device provides another device operational data to cause the presentation of the messaging application. For example, the wrist-wearable device 700 can detect the user input to initiate a messaging application, initiate and run the messaging application, and provide operational data to the AR device 800 and/or the HIPD 900 to cause presentation of the messaging application. Alternatively, the application can be initiated and run at a device other than the device that detected the user input. For example, the wrist-wearable device 700 can detect the hand gesture associated with initiating the messaging application and cause the HIPD 900 to run the messaging application and coordinate the presentation of the messaging application.

Further, the user 602 can provide a user input provided at the wrist-wearable device 700, the AR device 800, and/or the HIPD 900 to continue and/or complete an operation initiated at another device. For example, after initiating the messaging application via the wrist-wearable device 700 and while the AR device 800 presents the messaging user interface 612, the user 602 can provide an input at the HIPD 900 to prepare a response (e.g., shown by the swipe gesture performed on the HIPD 900). The user 602's gestures performed on the HIPD 900 can be provided and/or displayed on another device. For example, the user 602's swipe gestures performed on the HIPD 900 are displayed on a virtual keyboard of the messaging user interface 612 displayed by the AR device 800.

In some embodiments, the wrist-wearable device 700, the AR device 800, the HIPD 900, and/or other communicatively coupled devices can present one or more notifications to the user 602. The notification can be an indication of a new message, an incoming call, an application update, a status update, etc. The user 602 can select the notification via the wrist-wearable device 700, the AR device 800, or the HIPD 900 and cause presentation of an application or operation associated with the notification on at least one device. For example, the user 602 can receive a notification that a message was received at the wrist-wearable device 700, the AR device 800, the HIPD 900, and/or other communicatively coupled device and provide a user input at the wrist-wearable device 700, the AR device 800, and/or the HIPD 900 to review the notification, and the device detecting the user input can cause an application associated with the notification to be initiated and/or presented at the wrist-wearable device 700, the AR device 800, and/or the HIPD 900.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 800 can present to the user 602 game application data and the HIPD 900 can use a controller to provide inputs to the game. Similarly, the user 602 can use the wrist-wearable device 700 to initiate a camera of the AR device 800, and the user can use the wrist-wearable device 700, the AR device 800, and/or the HIPD 900 to manipulate the image capture (e.g., zoom in or out, apply filters, etc.) and capture image data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 7A and 7B illustrate an example wrist-wearable device 700, in accordance with some embodiments. FIG. 7A illustrates components of the wrist-wearable device 700, which can be used individually or in combination, including combinations that include other electronic devices and/or electronic components.

FIG. 7A shows a wearable band 710 and a watch body 720 (or capsule) being coupled, as discussed below, to form the wrist-wearable device 700. The wrist-wearable device 700 can perform various functions and/or operations associated with navigating through user interfaces and selectively opening applications.

As will be described in more detail below, operations executed by the wrist-wearable device 700 can include (i) presenting content to a user (e.g., displaying visual content via a display 705); (ii) detecting (e.g., sensing) user input (e.g., sensing a touch on peripheral button 723 and/or at a touch screen of the display 705, a hand gesture detected by sensors (e.g., biopotential sensors)); (iii) sensing biometric data via one or more sensors 713 (e.g., neuromuscular signals, heart rate, temperature, sleep, etc.); messaging (e.g., text, speech, video, etc.); image capture via one or more imaging devices or cameras 725; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 720, independently in the wearable band 710, and/or via an electronic communication between the watch body 720 and the wearable band 710. In some embodiments, functions can be executed on the wrist-wearable device 700 while an AR environment is being presented (e.g., via one of the AR systems 600a to 600d). As the skilled artisan will appreciate upon reading the descriptions provided herein, the novel wearable devices described herein can be used with other types of AR environments.

The wearable band 710 can be configured to be worn by a user such that an inner (or inside) surface of the wearable structure 711 of the wearable band 710 is in contact with the user's skin. When worn by a user, sensors 713 contact the user's skin. The sensors 713 can sense biometric data such as a user's heart rate, saturated oxygen level, temperature, sweat level, neuromuscular signal sensors, or a combination thereof. The sensors 713 can also sense data about a user's environment, including a user's motion, altitude, location, orientation, gait, acceleration, position, or a combination thereof. In some embodiments, the sensors 713 are configured to track a position and/or motion of the wearable band 710. The one or more sensors 713 can include any of the sensors defined above and/or discussed below with respect to FIG. 7B.

The one or more sensors 713 can be distributed on an inside and/or an outside surface of the wearable band 710. In some embodiments, the one or more sensors 713 are uniformly spaced along the wearable band 710. Alternatively, in some embodiments, the one or more sensors 713 are positioned at distinct points along the wearable band 710. As shown in FIG. 7A, the one or more sensors 713 can be the same or distinct. For example, in some embodiments, the one or more sensors 713 can be shaped as a pill (e.g., sensor 713a), an oval, a circle a square, an oblong (e.g., sensor 713c) and/or any other shape that maintains contact with the user's skin (e.g., such that neuromuscular signal and/or other biometric data can be accurately measured at the user's skin). In some embodiments, the one or more sensors 713 are aligned to form pairs of sensors (e.g., for sensing neuromuscular signals based on differential sensing within each respective sensor). For example, sensor 713b is aligned with an adjacent sensor to form sensor pair 714a and sensor 713d is aligned with an adjacent sensor to form sensor pair 714b. In some embodiments, the wearable band 710 does not have a sensor pair. Alternatively, in some embodiments, the wearable band 710 has a predetermined number of sensor pairs (one pair of sensors, three pairs of sensors, four pairs of sensors, six pairs of sensors, sixteen pairs of sensors, etc.).

The wearable band 710 can include any suitable number of sensors 713. In some embodiments, the number and arrangements of sensors 713 depend on the particular application for which the wearable band 710 is used. For instance, a wearable band 710 configured as an armband, wristband, or chest-band may include a plurality of sensors 713 with different number of sensors 713 and different arrangement for each use case, such as medical use cases, compared to gaming or general day-to-day use cases.

In accordance with some embodiments, the wearable band 710 further includes an electrical ground electrode and a shielding electrode. The electrical ground and shielding electrodes, like the sensors 713, can be distributed on the inside surface of the wearable band 710 such that they contact a portion of the user's skin. For example, the electrical ground and shielding electrodes can be at an inside surface of coupling mechanism 716 or an inside surface of a wearable structure 711. The electrical ground and shielding electrodes can be formed and/or use the same components as the sensors 713. In some embodiments, the wearable band 710 includes more than one electrical ground electrode and more than one shielding electrode.

The sensors 713 can be formed as part of the wearable structure 711 of the wearable band 710. In some embodiments, the sensors 713 are flush or substantially flush with the wearable structure 711 such that they do not extend beyond the surface of the wearable structure 711. While flush with the wearable structure 711, the sensors 713 are still configured to contact the user's skin (e.g., via a skin-contacting surface). Alternatively, in some embodiments, the sensors 713 extend beyond the wearable structure 711 a predetermined distance (e.g., 0.1 mm to 2 mm) to make contact and depress into the user's skin. In some embodiments, the sensors 713 are coupled to an actuator (not shown) configured to adjust an extension height (e.g., a distance from the surface of the wearable structure 711) of the sensors 713 such that the sensors 713 make contact and depress into the user's skin. In some embodiments, the actuators adjust the extension height between 0.01 mm to 1.2 mm. This allows the user to customize the positioning of the sensors 713 to improve the overall comfort of the wearable band 710 when worn while still allowing the sensors 713 to contact the user's skin. In some embodiments, the sensors 713 are indistinguishable from the wearable structure 711 when worn by the user.

The wearable structure 711 can be formed of an elastic material, elastomers, etc., configured to be stretched and fitted to be worn by the user. In some embodiments, the wearable structure 711 is a textile or woven fabric. As described above, the sensors 713 can be formed as part of a wearable structure 711. For example, the sensors 713 can be molded into the wearable structure 711 or be integrated into a woven fabric (e.g., the sensors 713 can be sewn into the fabric and mimic the pliability of fabric (e.g., the sensors 713 can be constructed from a series of woven strands of fabric)).

The wearable structure 711 can include flexible electronic connectors that interconnect the sensors 713, the electronic circuitry, and/or other electronic components (described below in reference to FIG. 7B) that are enclosed in the wearable band 710. In some embodiments, the flexible electronic connectors are configured to interconnect the sensors 713, the electronic circuitry, and/or other electronic components of the wearable band 710 with respective sensors and/or other electronic components of another electronic device (e.g., watch body 720). The flexible electronic connectors are configured to move with the wearable structure 711 such that the user adjustment to the wearable structure 711 (e.g., resizing, pulling, folding, etc.) does not stress or strain the electrical coupling of components of the wearable band 710.

As described above, the wearable band 710 is configured to be worn by a user. In particular, the wearable band 710 can be shaped or otherwise manipulated to be worn by a user. For example, the wearable band 710 can be shaped to have a substantially circular shape such that it can be configured to be worn on the user's lower arm or wrist. Alternatively, the wearable band 710 can be shaped to be worn on another body part of the user, such as the user's upper arm (e.g., around a bicep), forearm, chest, legs, etc. The wearable band 710 can include a retaining mechanism 712 (e.g., a buckle, a hook and loop fastener, etc.) for securing the wearable band 710 to the user's wrist or other body part. While the wearable band 710 is worn by the user, the sensors 713 sense data (referred to as sensor data) from the user's skin. In particular, the sensors 713 of the wearable band 710 obtain (e.g., sense and record) neuromuscular signals.

The sensed data (e.g., sensed neuromuscular signals) can be used to detect and/or determine the user's intention to perform certain motor actions. In particular, the sensors 713 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 705 of the wrist-wearable device 700 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 713 can be used to provide a user with an enhanced interaction with a physical object (e.g., devices communicatively coupled with the wearable band 710) and/or a virtual object in an artificial-reality application generated by an artificial-reality system (e.g., user interface objects presented on the display 705 or another computing device (e.g., a smartphone)).

In some embodiments, the wearable band 710 includes one or more haptic devices 746 (FIG. 7B; e.g., a vibratory haptic actuator) that are configured to provide haptic feedback (e.g., a cutaneous and/or kinesthetic sensation, etc.) to the user's skin. The sensors 713, and/or the haptic devices 746 can be configured to operate in conjunction with multiple applications including, without limitation, health monitoring, social media, games, and artificial reality (e.g., the applications associated with artificial reality).

The wearable band 710 can also include coupling mechanism 716 (e.g., a cradle or a shape of the coupling mechanism can correspond to shape of the watch body 720 of the wrist-wearable device 700) for detachably coupling a capsule (e.g., a computing unit) or watch body 720 (via a coupling surface of the watch body 720) to the wearable band 710. In particular, the coupling mechanism 716 can be configured to receive a coupling surface proximate to the bottom side of the watch body 720 (e.g., a side opposite to a front side of the watch body 720 where the display 705 is located), such that a user can push the watch body 720 downward into the coupling mechanism 716 to attach the watch body 720 to the coupling mechanism 716. In some embodiments, the coupling mechanism 716 can be configured to receive a top side of the watch body 720 (e.g., a side proximate to the front side of the watch body 720 where the display 705 is located) that is pushed upward into the cradle, as opposed to being pushed downward into the coupling mechanism 716. In some embodiments, the coupling mechanism 716 is an integrated component of the wearable band 710 such that the wearable band 710 and the coupling mechanism 716 are a single unitary structure. In some embodiments, the coupling mechanism 716 is a type of frame or shell that allows the watch body 720 coupling surface to be retained within or on the wearable band 710 coupling mechanism 716 (e.g., a cradle, a tracker band, a support base, a clasp, etc.).

The coupling mechanism 716 can allow for the watch body 720 to be detachably coupled to the wearable band 710 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 720 to the wearable band 710 and to decouple the watch body 720 from the wearable band 710. For example, a user can twist, slide, turn, push, pull, or rotate the watch body 720 relative to the wearable band 710, or a combination thereof, to attach the watch body 720 to the wearable band 710 and to detach the watch body 720 from the wearable band 710. Alternatively, as discussed below, in some embodiments, the watch body 720 can be decoupled from the wearable band 710 by actuation of the release mechanism 729.

The wearable band 710 can be coupled with a watch body 720 to increase the functionality of the wearable band 710 (e.g., converting the wearable band 710 into a wrist-wearable device 700, adding an additional computing unit and/or battery to increase computational resources and/or a battery life of the wearable band 710, adding additional sensors to improve sensed data, etc.). As described above, the wearable band 710 (and the coupling mechanism 716) is configured to operate independently (e.g., execute functions independently) from watch body 720. For example, the coupling mechanism 716 can include one or more sensors 713 that contact a user's skin when the wearable band 710 is worn by the user and provide sensor data for determining control commands.

A user can detach the watch body 720 (or capsule) from the wearable band 710 in order to reduce the encumbrance of the wrist-wearable device 700 to the user. For embodiments in which the watch body 720 is removable, the watch body 720 can be referred to as a removable structure, such that in these embodiments the wrist-wearable device 700 includes a wearable portion (e.g., the wearable band 710) and a removable structure (the watch body 720).

Turning to the watch body 720, the watch body 720 can have a substantially rectangular or circular shape. The watch body 720 is configured to be worn by the user on their wrist or on another body part. More specifically, the watch body 720 is sized to be easily carried by the user, attached on a portion of the user's clothing, and/or coupled to the wearable band 710 (forming the wrist-wearable device 700). As described above, the watch body 720 can have a shape corresponding to the coupling mechanism 716 of the wearable band 710. In some embodiments, the watch body 720 includes a single release mechanism 729 or multiple release mechanisms (e.g., two release mechanisms 729 positioned on opposing sides of the watch body 720, such as spring-loaded buttons) for decoupling the watch body 720 and the wearable band 710. The release mechanism 729 can include, without limitation, a button, a knob, a plunger, a handle, a lever, a fastener, a clasp, a dial, a latch, or a combination thereof.

A user can actuate the release mechanism 729 by pushing, turning, lifting, depressing, shifting, or performing other actions on the release mechanism 729. Actuation of the release mechanism 729 can release (e.g., decouple) the watch body 720 from the coupling mechanism 716 of the wearable band 710, allowing the user to use the watch body 720 independently from wearable band 710, and vice versa. For example, decoupling the watch body 720 from the wearable band 710 can allow the user to capture images using rear-facing camera 725B. Although the coupling mechanism 716 is shown positioned at a corner of watch body 720, the release mechanism 729 can be positioned anywhere on watch body 720 that is convenient for the user to actuate. In addition, in some embodiments, the wearable band 710 can also include a respective release mechanism for decoupling the watch body 720 from the coupling mechanism 716. In some embodiments, the release mechanism 729 is optional and the watch body 720 can be decoupled from the coupling mechanism 716 as described above (e.g., via twisting, rotating, etc.).

The watch body 720 can include one or more peripheral buttons 723 and 727 for performing various operations at the watch body 720. For example, the peripheral buttons 723 and 727 can be used to turn on or wake (e.g., transition from a sleep state to an active state) the display 705, unlock the watch body 720, increase or decrease a volume, increase or decrease brightness, interact with one or more applications, interact with one or more user interfaces, etc. Additionally, or alternatively, in some embodiments, the display 705 operates as a touch screen and allows the user to provide one or more inputs for interacting with the watch body 720.

In some embodiments, the watch body 720 includes one or more sensors 721. The sensors 721 of the watch body 720 can be the same or distinct from the sensors 713 of the wearable band 710. The sensors 721 of the watch body 720 can be distributed on an inside and/or an outside surface of the watch body 720. In some embodiments, the sensors 721 are configured to contact a user's skin when the watch body 720 is worn by the user. For example, the sensors 721 can be placed on the bottom side of the watch body 720 and the coupling mechanism 716 can be a cradle with an opening that allows the bottom side of the watch body 720 to directly contact the user's skin. Alternatively, in some embodiments, the watch body 720 does not include sensors that are configured to contact the user's skin (e.g., including sensors internal and/or external to the watch body 720 that configured to sense data of the watch body 720 and the watch body 720's surrounding environment). In some embodiments, the sensors 713 are configured to track a position and/or motion of the watch body 720.

The watch body 720 and the wearable band 710 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 720 and the wearable band 710 can share data sensed by the sensors 713 and 721, as well as application- and device-specific information (e.g., active and/or available applications), output devices (e.g., display, speakers, etc.), input devices (e.g., touch screen, microphone, imaging sensors, etc.).

In some embodiments, the watch body 720 can include, without limitation, a front-facing camera 725A and/or a rear-facing camera 725B, sensors 721 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 763; FIG. 7B), a touch sensor, a sweat sensor, etc.). In some embodiments, the watch body 720 can include one or more haptic devices 776 (FIG. 7B; a vibratory haptic actuator) that is configured to provide haptic feedback (e.g., a cutaneous and/or kinesthetic sensation, etc.) to the user. The sensors 721 and/or the haptic device 776 can also be configured to operate in conjunction with multiple applications including, without limitation, health-monitoring applications, social media applications, game applications, and artificial-reality applications (e.g., the applications associated with artificial reality).

As described above, the watch body 720 and the wearable band 710, when coupled, can form the wrist-wearable device 700. When coupled, the watch body 720 and wearable band 710 operate as a single device to execute functions (operations, detections, communications, etc.) described herein. In some embodiments, each device is provided with particular instructions for performing the one or more operations of the wrist-wearable device 700. For example, in accordance with a determination that the watch body 720 does not include neuromuscular signal sensors, the wearable band 710 can include alternative instructions for performing associated instructions (e.g., providing sensed neuromuscular signal data to the watch body 720 via a different electronic device). Operations of the wrist-wearable device 700 can be performed by the watch body 720 alone or in conjunction with the wearable band 710 (e.g., via respective processors and/or hardware components) and vice versa. In some embodiments, operations of the wrist-wearable device 700, the watch body 720, and/or the wearable band 710 can be performed in conjunction with one or more processors and/or hardware components of another communicatively coupled device (e.g., the HIPD 900; FIGS. 9A-9B).

As described below with reference to the block diagram of FIG. 7B, the wearable band 710 and/or the watch body 720 can each include independent resources required to independently execute functions. For example, the wearable band 710 and/or the watch body 720 can each include a power source (e.g., a battery), a memory, data storage, a processor (e.g., a central processing unit (CPU)), communications, a light source, and/or input/output devices.

FIG. 7B shows block diagrams of a computing system 730 corresponding to the wearable band 710, and a computing system 760 corresponding to the watch body 720, according to some embodiments. A computing system of the wrist-wearable device 700 includes a combination of components of the wearable band computing system 730 and the watch body computing system 760, in accordance with some embodiments.

The watch body 720 and/or the wearable band 710 can include one or more components shown in watch body computing system 760. In some embodiments, a single integrated circuit includes all or a substantial portion of the components of the watch body computing system 760 are included in a single integrated circuit. Alternatively, in some embodiments, components of the watch body computing system 760 are included in a plurality of integrated circuits that are communicatively coupled. In some embodiments, the watch body computing system 760 is configured to couple (e.g., via a wired or wireless connection) with the wearable band computing system 730, which allows the computing systems to share components, distribute tasks, and/or perform other operations described herein (individually or as a single device).

The watch body computing system 760 can include one or more processors 779, a controller 777, a peripherals interface 761, a power system 795, and memory (e.g., a memory 780), each of which are defined above and described in more detail below.

The power system 795 can include a charger input 796, a power-management integrated circuit (PMIC) 797, and a battery 798, each are which are defined above. In some embodiments, a watch body 720 and a wearable band 710 can have respective charger inputs (e.g., charger input 796 and 757), respective batteries (e.g., battery 798 and 759), and can share power with each other (e.g., the watch body 720 can power and/or charge the wearable band 710, and vice versa). Although watch body 720 and/or the wearable band 710 can include respective charger inputs, a single charger input can charge both devices when coupled. The watch body 720 and the wearable band 710 can receive a charge using a variety of techniques. In some embodiments, the watch body 720 and the wearable band 710 can use a wired charging assembly (e.g., power cords) to receive the charge. Alternatively, or in addition, the watch body 720 and/or the wearable band 710 can be configured for wireless charging. For example, a portable charging device can be designed to mate with a portion of watch body 720 and/or wearable band 710 and wirelessly deliver usable power to a battery of watch body 720 and/or wearable band 710. The watch body 720 and the wearable band 710 can have independent power systems (e.g., power system 795 and 756) to enable each to operate independently. The watch body 720 and wearable band 710 can also share power (e.g., one can charge the other) via respective PMICs (e.g., PMICs 797 and 758) that can share power over power and ground conductors and/or over wireless charging antennas.

In some embodiments, the peripherals interface 761 can include one or more sensors 721, many of which listed below are defined above. The sensors 721 can include one or more coupling sensors 762 for detecting when the watch body 720 is coupled with another electronic device (e.g., a wearable band 710). The sensors 721 can include imaging sensors 763 (one or more of the cameras 725 and/or separate imaging sensors 763 (e.g., thermal-imaging sensors)). In some embodiments, the sensors 721 include one or more SpO2 sensors 764. In some embodiments, the sensors 721 include one or more biopotential-signal sensors (e.g., EMG sensors 765, which may be disposed on a user-facing portion of the watch body 720 and/or the wearable band 710). In some embodiments, the sensors 721 include one or more capacitive sensors 766. In some embodiments, the sensors 721 include one or more heart rate sensors 767. In some embodiments, the sensors 721 include one or more IMUs 768. In some embodiments, one or more IMUs 768 can be configured to detect movement of a user's hand or other location that the watch body 720 is placed or held.

In some embodiments, the peripherals interface 761 includes an NFC component 769, a global-position system (GPS) component 770, a long-term evolution (LTE) component 771, and/or a Wi-Fi and/or Bluetooth communication component 772. In some embodiments, the peripherals interface 761 includes one or more buttons 773 (e.g., the peripheral buttons 723 and 727 in FIG. 7A), which, when selected by a user, cause operations to be performed at the watch body 720. In some embodiments, the peripherals interface 761 includes one or more indicators, such as a light emitting diode (LED), to provide a user with visual indicators (e.g., message received, low battery, an active microphone, and/or a camera, etc.).

The watch body 720 can include at least one display 705 for displaying visual representations of information or data to the user, including user-interface elements and/or three-dimensional (3D) virtual objects. The display can also include a touch screen for inputting user inputs, such as touch gestures, swipe gestures, and the like. The watch body 720 can include at least one speaker 774 and at least one microphone 775 for providing audio signals to the user and receiving audio input from the user. The user can provide user inputs through the microphone 775 and can also receive audio output from the speaker 774 as part of a haptic event provided by the haptic controller 778. The watch body 720 can include at least one camera 725, including a front-facing camera 725A and a rear-facing camera 725B. The cameras 725 can include ultra-wide-angle cameras, wide-angle cameras, fish-eye cameras, spherical cameras, telephoto cameras, a depth-sensing cameras, or other types of cameras.

The watch body computing system 760 can include one or more haptic controllers 778 and associated componentry (e.g., haptic devices 776) for providing haptic events at the watch body 720 (e.g., a vibrating sensation or audio output in response to an event at the watch body 720). The haptic controllers 778 can communicate with one or more haptic devices 776, such as electroacoustic devices, including a speaker of the one or more speakers 774 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 778 can provide haptic events to respective haptic actuators that are capable of being sensed by a user of the watch body 720. In some embodiments, the one or more haptic controllers 778 can receive input signals from an application of the applications 782.

In some embodiments, the computer system 730 and/or the computer system 760 can include memory 780, which can be controlled by a memory controller of the one or more controllers 777 and/or one or more processors 779. In some embodiments, software components stored in the memory 780 include one or more applications 782 configured to perform operations at the watch body 720. In some embodiments, the one or more applications 782 include games, word processors, messaging applications, calling applications, web browsers, social media applications, media streaming applications, financial applications, calendars, clocks, etc. In some embodiments, software components stored in the memory 780 include one or more communication interface modules 783 as defined above. In some embodiments, software components stored in the memory 780 include one or more graphics modules 784 for rendering, encoding, and/or decoding audio and/or visual data; and one or more data management modules 785 for collecting, organizing, and/or providing access to the data 787 stored in memory 780. In some embodiments, one or more of applications 782 and/or one or more modules can work in conjunction with one another to perform various tasks at the watch body 720.

In some embodiments, software components stored in the memory 780 can include one or more operating systems 781 (e.g., a Linux-based operating system, an Android operating system, etc.). The memory 780 can also include data 787. The data 787 can include profile data 788A, sensor data 789A, media content data 790, and application data 791.

It should be appreciated that the watch body computing system 760 is an example of a computing system within the watch body 720, and that the watch body 720 can have more or fewer components than shown in the watch body computing system 760, combine two or more components, and/or have a different configuration and/or arrangement of the components. The various components shown in watch body computing system 760 are implemented in hardware, software, firmware, or a combination thereof, including one or more signal processing and/or application-specific integrated circuits.

Turning to the wearable band computing system 730, one or more components that can be included in the wearable band 710 are shown. The wearable band computing system 730 can include more or fewer components than shown in the watch body computing system 760, combine two or more components, and/or have a different configuration and/or arrangement of some or all of the components. In some embodiments, all, or a substantial portion of the components of the wearable band computing system 730 are included in a single integrated circuit. Alternatively, in some embodiments, components of the wearable band computing system 730 are included in a plurality of integrated circuits that are communicatively coupled. As described above, in some embodiments, the wearable band computing system 730 is configured to couple (e.g., via a wired or wireless connection) with the watch body computing system 760, which allows the computing systems to share components, distribute tasks, and/or perform other operations described herein (individually or as a single device).

The wearable band computing system 730, similar to the watch body computing system 760, can include one or more processors 749, one or more controllers 747 (including one or more haptics controller 748), a peripherals interface 731 that can include one or more sensors 713 and other peripheral devices, power source (e.g., a power system 756), and memory (e.g., a memory 750) that includes an operating system (e.g., an operating system 751), data (e.g., data 754 including profile data 788B, sensor data 789B, etc.), and one or more modules (e.g., a communications interface module 752, a data management module 753, etc.).

The one or more sensors 713 can be analogous to sensors 721 of the computer system 760 in light of the definitions above. For example, sensors 713 can include one or more coupling sensors 732, one or more SpO2 sensors 734, one or more EMG sensors 735, one or more capacitive sensors 736, one or more heart rate sensors 737, and one or more IMU sensors 738.

The peripherals interface 731 can also include other components analogous to those included in the peripheral interface 761 of the computer system 760, including an NFC component 739, a GPS component 740, an LTE component 741, a Wi-Fi and/or Bluetooth communication component 742, and/or one or more haptic devices 776 as described above in reference to peripherals interface 761. In some embodiments, the peripherals interface 731 includes one or more buttons 743, a display 733, a speaker 744, a microphone 745, and a camera 755. In some embodiments, the peripherals interface 731 includes one or more indicators, such as an LED.

It should be appreciated that the wearable band computing system 730 is an example of a computing system within the wearable band 710, and that the wearable band 710 can have more or fewer components than shown in the wearable band computing system 730, combine two or more components, and/or have a different configuration and/or arrangement of the components. The various components shown in wearable band computing system 730 can be implemented in one or a combination of hardware, software, and firmware, including one or more signal processing and/or application-specific integrated circuits.

The wrist-wearable device 700 with respect to FIG. 7A is an example of the wearable band 710 and the watch body 720 coupled, so the wrist-wearable device 700 will be understood to include the components shown and described for the wearable band computing system 730 and the watch body computing system 760. In some embodiments, wrist-wearable device 700 has a split architecture (e.g., a split mechanical architecture or a split electrical architecture) between the watch body 720 and the wearable band 710. In other words, all of the components shown in the wearable band computing system 730 and the watch body computing system 760 can be housed or otherwise disposed in a combined watch device 700, or within individual components of the watch body 720, wearable band 710, and/or portions thereof (e.g., a coupling mechanism 716 of the wearable band 710).

The techniques described above can be used with any device for sensing neuromuscular signals, including the arm-wearable devices of FIG. 7A-7B, but could also be used with other types of wearable devices for sensing neuromuscular signals (such as body-wearable or head-wearable devices that might have neuromuscular sensors closer to the brain or spinal column).

In some embodiments, a wrist-wearable device 700 can be used in conjunction with a head-wearable device described below (e.g., AR device 800 and VR device 810) and/or an HIPD 900, and the wrist-wearable device 700 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 800 and VR device 810.

### Example Head-Wearable Devices

FIGS. 8A, 8B-1, 8B-2, and 8C show example head-wearable devices, in accordance with some embodiments. Head-wearable devices can include, but are not limited to, AR devices 810 (e.g., AR or smart eyewear devices, such as smart glasses, smart monocles, smart contacts, etc.), VR devices 810 (e.g., VR headsets, head-mounted displays (HMD)s, etc.), or other ocularly coupled devices. The AR devices 800 and the VR devices 810 are instances of the augmented-reality headset 100 described in reference to FIGS. 1-5 herein, such that the head-wearable device should be understood to have the features of the AR devices 800 and/or the VR devices 810, and vice versa. The AR devices 800 and the VR devices 810 can perform various functions and/or operations associated with navigating through user interfaces and selectively opening applications, as well as the functions and/or operations.

In some embodiments, an AR system (e.g., AR systems 600a-600b; FIGS. 6A-6B) includes an AR device 800 (as shown in FIG. 8A) and/or VR device 810 (as shown in FIGS. 8B-1-B-2). In some embodiments, the AR device 800 and the VR device 810 can include one or more analogous components (e.g., components for presenting interactive artificial-reality environments, such as processors, memory, and/or presentation devices, including one or more displays and/or one or more waveguides), some of which are described in more detail with respect to FIG. 8C. The head-wearable devices can use display projectors (e.g., display projector assemblies 807A and 807B) and/or waveguides for projecting representations of data to a user. Some embodiments of head-wearable devices do not include displays.

FIG. 8A shows an example visual depiction of the AR device 800 (e.g., which may also be described herein as augmented-reality glasses and/or smart glasses). The AR device 800 can work in conjunction with additional electronic components that are not shown in FIG. 8A, such as a wearable accessory device and/or an intermediary processing device, in electronic communication or otherwise configured to be used in conjunction with the AR device 800. In some embodiments, the wearable accessory device and/or the intermediary processing device may be configured to couple with the AR device 800 via a coupling mechanism in electronic communication with a coupling sensor 824, where the coupling sensor 824 can detect when an electronic device becomes physically or electronically coupled with the AR device 800. In some embodiments, the AR device 800 can be configured to couple to a housing (e.g., a portion of frame 804 or temple arms 805), which may include one or more additional coupling mechanisms configured to couple with additional accessory devices. The components shown in FIG. 8A can be implemented in hardware, software, firmware, or a combination thereof, including one or more signal-processing components and/or application-specific integrated circuits (ASICs).

The AR device 800 includes mechanical glasses components, including a frame 804 configured to hold one or more lenses (e.g., one or both lenses 806-1 and 806-2). One of ordinary skill in the art will appreciate that the AR device 800 can include additional mechanical components, such as hinges configured to allow portions of the frame 804 of the AR device 800 to be folded and unfolded, a bridge configured to span the gap between the lenses 806-1 and 806-2 and rest on the user's nose, nose pads configured to rest on the bridge of the nose and provide support for the AR device 800, earpieces configured to rest on the user's ears and provide additional support for the AR device 800, temple arms 805 configured to extend from the hinges to the earpieces of the AR device 800, and the like. One of ordinary skill in the art will further appreciate that some examples of the AR device 800 can include none of the mechanical components described herein. For example, smart contact lenses configured to present artificial-reality to users may not include any components of the AR device 800.

The lenses 806-1 and 806-2 can be individual displays or display devices (e.g., a waveguide for projected representations). The lenses 806-1 and 806-2 may act together or independently to present an image or series of images to a user. In some embodiments, the lenses 806-1 and 806-2 can operate in conjunction with one or more display projector assemblies 807A and 807B to present image data to a user. While the AR device 800 includes two displays, embodiments of this disclosure may be implemented in AR devices with a single near-eye display (NED) or more than two NEDs.

The AR device 800 includes electronic components, many of which will be described in more detail below with respect to FIG. 8C. Some example electronic components are illustrated in FIG. 8A, including sensors 823-1, 823-2, 823-3, 823-4, 823-5, and 823-6, which can be distributed along a substantial portion of the frame 804 of the AR device 800. The different types of sensors are described below in reference to FIG. 8C. The AR device 800 also includes a left camera 839A and a right camera 839B, which are located on different sides of the frame 804. And the eyewear device includes one or more processors 848A and 848B (e.g., an integral microprocessor, such as an ASIC) that is embedded into a portion of the frame 804.

FIGS. 8B-1 and 8B-2 show an example visual depiction of the VR device 810 (e.g., a head-mounted display (HMD) 812, also referred to herein as an artificial-reality headset, a head-wearable device, a VR headset, etc.). The HMD 812 includes a front body 814 and a frame 816 (e.g., a strap or band) shaped to fit around a user's head. In some embodiments, the front body 814 and/or the frame 816 includes one or more electronic elements for facilitating presentation of and/or interactions with an AR and/or VR system (e.g., displays, processors (e.g., processor 848A-1), IMUs, tracking emitter or detectors, sensors, etc.). In some embodiments, the HMD 812 includes output audio transducers (e.g., an audio transducer 818-1), as shown in FIG. 8B-2. In some embodiments, one or more components, such as the output audio transducer(s) 818-1 and the frame 816, can be configured to attach and detach (e.g., are detachably attachable) to the HMD 812 (e.g., a portion or all of the frame 816, and/or the output audio transducer 818-1), as shown in FIG. 8B-2. In some embodiments, coupling a detachable component to the HMD 812 causes the detachable component to come into electronic communication with the HMD 812. The VR device 810 includes electronic components, many of which will be described in more detail below with respect to FIG. 8C

FIG. 8B-1 to 8B-2 also show that the VR device 810 one or more cameras, such as the left camera 839A and the right camera 839B, which can be analogous to the left and right cameras on the frame 804 of the AR device 800. In some embodiments, the VR device 810 includes one or more additional cameras (e.g., cameras 839C and 839D), which can be configured to augment image data obtained by the cameras 839A and 839B by providing more information. For example, the camera 839C can be used to supply color information that is not discerned by cameras 839A and 839B. In some embodiments, one or more of the cameras 839A to 839D can include an optional IR cut filter configured to remove IR light from being received at the respective camera sensors.

The VR device 810 can include a housing 890 storing one or more components of the VR device 810 and/or additional components of the VR device 810. The housing 890 can be a modular electronic device configured to couple with the VR device 810 (or an AR device 800) and supplement and/or extend the capabilities of the VR device 810 (or an AR device 800). For example, the housing 890 can include additional sensors, cameras, power sources, processors (e.g., processor 848A-2), etc. to improve and/or increase the functionality of the VR device 810. Examples of the different components included in the housing 890 are described below in reference to FIG. 8C.

Alternatively or in addition, in some embodiments, the head-wearable device, such as the VR device 810 and/or the AR device 800), includes, or is communicatively coupled to, another external device (e.g., a paired device), such as an HIPD 9 (discussed below in reference to FIGS. 9A-9B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 900, an optional neckband, and/or wearable accessory device) with the head-wearable devices (e.g., an AR device 800 and/or VR device 810) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 900) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 900, can process information generated by one or more sensors of its sensors and/or information provided by other communicatively coupled devices. For example, a head-wearable device can include an IMU, and the intermediary processing device (neckband and/or an HIPD 900) can compute all inertial and spatial calculations from the IMUs located on the head-wearable device. Additional examples of processing performed by a communicatively coupled device, such as the HIPD 900, are provided below in reference to FIGS. 9A and 9B.

Artificial-reality systems may include a variety of types of visual feedback mechanisms. For example, display devices in the AR devices 800 and/or the VR devices 810 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 800 and/or the VR device 810 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 800 and the VR device 810, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 800 and/or the VR device 810 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 700, an HIPD 900, etc.), and/or other devices described herein.

FIG. 8C illustrates a computing system 820 and an optional housing 890, each of which show components that can be included in a head-wearable device (e.g., the AR device 800 and/or the VR device 810). In some embodiments, more or less components can be included in the optional housing 890 depending on practical restraints of the respective head-wearable device being described. Additionally or alternatively, the optional housing 890 can include additional components to expand and/or augment the functionality of a head-wearable device.

In some embodiments, the computing system 820 and/or the optional housing 890 can include one or more peripheral interfaces 822A and 822B, one or more power systems 842A and 842B (including charger input 843, PMIC 844, and battery 845), one or more controllers 846A 846B (including one or more haptic controllers 847), one or more processors 848A and 848B (as defined above, including any of the examples provided), and memory 850A and 850B, which can all be in electronic communication with each other. For example, the one or more processors 848A and/or 848B can be configured to execute instructions stored in the memory 850A and/or 850B, which can cause a controller of the one or more controllers 846A and/or 846B to cause operations to be performed at one or more peripheral devices of the peripherals interfaces 822A and/or 822B. In some embodiments, each operation described can occur based on electrical power provided by the power system 842A and/or 842B.

In some embodiments, the peripherals interface 822A can include one or more devices configured to be part of the computing system 820, many of which have been defined above and/or described with respect to wrist-wearable devices shown in FIGS. 7A and 7B. For example, the peripherals interface can include one or more sensors 823A. Some example sensors include: one or more coupling sensors 824, one or more acoustic sensors 825, one or more imaging sensors 826, one or more EMG sensors 827, one or more capacitive sensors 828, and/or one or more IMUs 829. In some embodiments, the sensors 823A further include depth sensors 867, light sensors 868 and/or any other types of sensors defined above or described with respect to any other embodiments discussed herein.

In some embodiments, the peripherals interface can include one or more additional peripheral devices, including one or more NFC devices 830, one or more GPS devices 831, one or more LTE devices 832, one or more WiFi and/or Bluetooth devices 833, one or more buttons 834 (e.g., including buttons that are slidable or otherwise adjustable), one or more displays 835A, one or more speakers 836A, one or more microphones 837A, one or more cameras 838A (e.g., including the a first camera 839-1 through nth camera 839-n, which are analogous to the left camera 839A and/or the right camera 839B), one or more haptic devices 840; and/or any other types of peripheral devices defined above or described with respect to any other embodiments discussed herein.

The head-wearable devices can include a variety of types of visual feedback mechanisms (e.g., presentation devices). For example, display devices in the AR device 800 and/or the VR device 810 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 835A can be coupled to each of the lenses 806-1 and 806-2 of the AR device 800. The displays 835A coupled to each of the lenses 806-1 and 806-2 can act together or independently to present an image or series of images to a user. In some embodiments, the AR device 800 and/or the VR device 810 includes a single display 835A (e.g., a near-eye display) or more than two displays 835A.

In some embodiments, a first set of one or more displays 835A can be used to present an augmented-reality environment, and a second set of one or more display devices 835A can be used to present a virtual-reality environment. In some embodiments, one or more waveguides are used in conjunction with presenting artificial-reality content to the user of the AR device 800 and/or the VR device 810 (e.g., as a means of delivering light from a display projector assembly and/or one or more displays 835A to the user's eyes). In some embodiments, one or more waveguides are fully or partially integrated into the AR device 800 and/or the VR device 810. Additionally, or alternatively to display screens, some artificial-reality systems include one or more projection systems. For example, display devices in the AR device 800 and/or the VR device 810 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 835A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 835A for presenting information to users. For example, an external display 835A can be used to show a current battery level, network activity (e.g., connected, disconnected, etc.), current activity (e.g., playing a game, in a call, in a meeting, watching a movie, etc.), and/or other relevant information. In some embodiments, the external displays 835A can be used to communicate with others. For example, a user of the head-wearable device can cause the external displays 835A to present a do not disturb notification. The external displays 835A can also be used by the user to share any information captured by the one or more components of the peripherals interface 822A and/or generated by head-wearable device (e.g., during operation and/or performance of one or more applications).

The memory 850A can include instructions and/or data executable by one or more processors 848A (and/or processors 848B of the housing 890) and/or a memory controller of the one or more controllers 846A (and/or controller 846B of the housing 890). The memory 850A can include one or more operating systems 851; one or more applications 852; one or more communication interface modules 853A; one or more graphics modules 854A; one or more AR processing modules 855A; and/or any other types of modules or components defined above or described with respect to any other embodiments discussed herein.

The data 860 stored in memory 850A can be used in conjunction with one or more of the applications and/or programs discussed above. The data 860 can include profile data 861; sensor data 862; media content data 863; AR application data 864; and/or any other types of data defined above or described with respect to any other embodiments discussed herein.

In some embodiments, the controller 846A of the head-wearable devices processes information generated by the sensors 823A on the head-wearable devices and/or another component of the head-wearable devices and/or communicatively coupled with the head-wearable devices (e.g., components of the housing 890, such as components of peripherals interface 822B). For example, the controller 846A can process information from the acoustic sensors 825 and/or image sensors 826. For each detected sound, the controller 846A can perform a direction of arrival (DOA) estimation to estimate a direction from which the detected sound arrived at a head-wearable device. As one or more of the acoustic sensors 825 detects sounds, the controller 846A can populate an audio data set with the information (e.g., represented by sensor data 862).

In some embodiments, a physical electronic connector can convey information between the head-wearable devices and another electronic device, and/or between one or more processors 848A of the head-wearable devices and the controller 846A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 900) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 800 and/or the VR device 810 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 8B-1 and 8B-2 show the VR device 810 having cameras 839A-839D, which can be used to provide depth information for creating a voxel field and a two-dimensional mesh to provide object information to the user to avoid collisions.

The optional housing 890 can include analogous components to those describe above with respect to the computing system 820. For example, the optional housing 890 can include a respective peripherals interface 822B including more or less components to those described above with respect to the peripherals interface 822A. As described above, the components of the optional housing 890 can be used augment and/or expand on the functionality of the head-wearable devices. For example, the optional housing 890 can include respective sensors 823B, speakers 836B, displays 835B, microphones 837B, cameras 838B, and/or other components to capture and/or present data. Similarly, the optional housing 890 can include one or more processors 848B, controllers 846B, and/or memory 850B (including respective communication interface modules 853B; one or more graphics modules 854B; one or more AR processing modules 855B, etc.) that can be used individually and/or in conjunction with the components of the computing system 820.

The techniques described above in FIGS. 8A-8C can be used with different head-wearable devices. In some embodiments, the head-wearable devices (e.g., the AR device 800 and/or the VR device 810) can be used in conjunction with one or more wearable device such as a wrist-wearable device 700 (or components thereof). Having thus described example the head-wearable devices, attention will now be turned to example handheld intermediary processing devices, such as HIPD 900.

### Example Handheld Intermediary Processing Devices

FIGS. 9A and 9B illustrate an example handheld intermediary processing device (HIPD) 900, in accordance with some embodiments. The HIPD 900 can perform various functions and/or operations associated with navigating through user interfaces and selectively opening applications, as well as the functions and/or operations.

FIG. 9A shows a top view 905 and a side view 925 of the HIPD 900. The HIPD 900 is configured to communicatively couple with one or more wearable devices (or other electronic devices) associated with a user. For example, the HIPD 900 is configured to communicatively couple with a user's wrist-wearable device 700 (or components thereof, such as the watch body 720 and the wearable band 710), AR device 800, and/or VR device 810. The HIPD 900 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 900 can successfully be communicatively coupled with an electronic device, such as a wearable device).

The HIPD 900 can perform various functions independently and/or in conjunction with one or more wearable devices (e.g., wrist-wearable device 700, AR device 800, VR device 810, etc.). The HIPD 900 is configured to increase and/or improve the functionality of communicatively coupled devices, such as the wearable devices. The HIPD 900 is configured to perform one or more functions or operations associated with interacting with user interfaces and applications of communicatively coupled devices, interacting with an AR environment, interacting with VR environment, and/or operating as a human-machine interface controller. Additionally, as will be described in more detail below, functionality and/or operations of the HIPD 900 can include, without limitation, task offloading and/or handoffs; thermals offloading and/or handoffs; 6 degrees of freedom (6DoF) raycasting and/or gaming (e.g., using imaging devices or cameras 914A and 914B, which can be used for simultaneous localization and mapping (SLAM) and/or with other image processing techniques); portable charging; messaging; image capturing via one or more imaging devices or cameras (e.g., cameras 922A and 922B); sensing user input (e.g., sensing a touch on a multi-touch input surface 902); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 900 and/or in communication between the HIPD 900 and another wearable device described herein. In some embodiments, functions can be executed on the HIPD 900 in conjunction with an AR environment. As the skilled artisan will appreciate upon reading the descriptions provided herein, the novel the HIPD 900 described herein can be used with any type of suitable AR environment.

While the HIPD 900 is communicatively coupled with a wearable device and/or other electronic device, the HIPD 900 is configured to perform one or more operations initiated at the wearable device and/or the other electronic device. In particular, one or more operations of the wearable device and/or the other electronic device can be offloaded to the HIPD 900 to be performed. The HIPD 900 performs the one or more operations of the wearable device and/or the other electronic device and provides to data corresponded to the completed operations to the wearable device and/or the other electronic device. For example, a user can initiate a video stream using AR device 800 and back-end tasks associated with performing the video stream (e.g., video rendering) can be offloaded to the HIPD 900, which the HIPD 900 performs and provides corresponding data to the AR device 800 to perform remaining front-end tasks associated with the video stream (e.g., presenting the rendered video data via a display of the AR device 800). In this way, the HIPD 900, which has more computational resources and greater thermal headroom than a wearable device, can perform computationally intensive tasks for the wearable device improving performance of an operation performed by the wearable device.

The HIPD 900 includes a multi-touch input surface 902 on a first side (e.g., a front surface) that is configured to detect one or more user inputs. In particular, the multi-touch input surface 902 can detect single tap inputs, multi-tap inputs, swipe gestures and/or inputs, force-based and/or pressure-based touch inputs, held taps, and the like. The multi-touch input surface 902 is configured to detect capacitive touch inputs and/or force (and/or pressure) touch inputs. The multi-touch input surface 902 includes a first touch-input surface 904 defined by a surface depression, and a second touch-input surface 906 defined by a substantially planar portion. The first touch-input surface 904 can be disposed adjacent to the second touch-input surface 906. In some embodiments, the first touch-input surface 904 and the second touch-input surface 906 can be different dimensions, shapes, and/or cover different portions of the multi-touch input surface 902. For example, the first touch-input surface 904 can be substantially circular and the second touch-input surface 906 is substantially rectangular. In some embodiments, the surface depression of the multi-touch input surface 902 is configured to guide user handling of the HIPD 900. In particular, the surface depression is configured such that the user holds the HIPD 900 upright when held in a single hand (e.g., such that the using imaging devices or cameras 914A and 914B are pointed toward a ceiling or the sky). Additionally, the surface depression is configured such that the user's thumb rests within the first touch-input surface 904.

In some embodiments, the different touch-input surfaces include a plurality of touch-input zones. For example, the second touch-input surface 906 includes at least a first touch-input zone 908 within a second touch-input zone 906 and a third touch-input zone 910 within the first touch-input zone 908. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 908 causes the HIPD 900 to perform a first command and a user input detected within the second touch-input zone 906 causes the HIPD 900 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 908 can be configured to detect force touch inputs (e.g., a magnitude at which the user presses down) and capacitive touch inputs, and the second touch-input zone 906 can be configured to detect capacitive touch inputs.

The HIPD 900 includes one or more sensors 951 for sensing data used in the performance of one or more operations and/or functions. For example, the HIPD 900 can include an IMU that is used in conjunction with cameras 914 for 3-dimensional object manipulation (e.g., enlarging, moving, destroying, etc. an object) in an AR or VR environment. Non-limiting examples of the sensors 951 included in the HIPD 900 include a light sensor, a magnetometer, a depth sensor, a pressure sensor, and a force sensor. Additional examples of the sensors 951 are provided below in reference to FIG. 9B.

The HIPD 900 can include one or more light indicators 912 to provide one or more notifications to the user. In some embodiments, the light indicators are LEDs or other types of illumination devices. The light indicators 912 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 904. The light indicators can be illuminated in different colors and/or patterns to provide the user with one or more notifications and/or information about the device. For example, a light indicator positioned around the first touch-input surface 904 can flash when the user receives a notification (e.g., a message), change red when the HIPD 900 is out of power, operate as a progress bar (e.g., a light ring that is closed when a task is completed (e.g., 0% to 100%)), operates as a volume indicator, etc.).

In some embodiments, the HIPD 900 includes one or more additional sensors on another surface. For example, as shown FIG. 9A, HIPD 900 includes a set of one or more sensors (e.g., sensor set 920) on an edge of the HIPD 900. The sensor set 920, when positioned on an edge of the of the HIPD 900, can be pe positioned at a predetermined tilt angle (e.g., 26 degrees), which allows the sensor set 920 to be angled toward the user when placed on a desk or other flat surface. Alternatively, in some embodiments, the sensor set 920 is positioned on a surface opposite the multi-touch input surface 902 (e.g., a back surface). The one or more sensors of the sensor set 920 are discussed in detail below.

The side view 925 of the of the HIPD 900 shows the sensor set 920 and camera 914B. The sensor set 920 includes one or more cameras 922A and 922B, a depth projector 924, an ambient light sensor 928, and a depth receiver 930. In some embodiments, the sensor set 920 includes a light indicator 926. The light indicator 926 can operate as a privacy indicator to let the user and/or those around them know that a camera and/or microphone is active. The sensor set 920 is configured to capture a user's facial expression such that the user can puppet a custom avatar (e.g., showing emotions, such as smiles, laughter, etc., on the avatar or a digital representation of the user). The sensor set 920 can be configured as a side stereo RGB system, a rear indirect Time-of-Flight (iToF) system, or a rear stereo RGB system. As the skilled artisan will appreciate upon reading the descriptions provided herein, the novel HIPD 900 described herein can use different sensor set 920 configurations and/or sensor set 920 placement.

In some embodiments, the HIPD 900 includes one or more haptic devices 971 (FIG. 9B; e.g., a vibratory haptic actuator) that are configured to provide haptic feedback (e.g., kinesthetic sensation). The sensors 951, and/or the haptic devices 971 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 900 is configured to operate without a display. However, in optional embodiments, the HIPD 900 can include a display 968 (FIG. 9B). The HIPD 900 can also income one or more optional peripheral buttons 967 (FIG. 9B). For example, the peripheral buttons 967 can be used to turn on or turn off the HIPD 900. Further, the HIPD 900 housing can be formed of polymers and/or elastomer elastomers. The HIPD 900 can be configured to have a non-slip surface to allow the HIPD 900 to be placed on a surface without requiring a user to watch over the HIPD 900. In other words, the HIPD 900 is designed such that it would not easily slide off a surfaces. In some embodiments, the HIPD 900 include one or magnets to couple the HIPD 900 to another surface. This allows the user to mount the HIPD 900 to different surfaces and provide the user with greater flexibility in use of the HIPD 900.

As described above, the HIPD 900 can distribute and/or provide instructions for performing the one or more tasks at the HIPD 900 and/or a communicatively coupled device. For example, the HIPD 900 can identify one or more back-end tasks to be performed by the HIPD 900 and one or more front-end tasks to be performed by a communicatively coupled device. While the HIPD 900 is configured to offload and/or handoff tasks of a communicatively coupled device, the HIPD 900 can perform both back-end and front-end tasks (e.g., via one or more processors, such as CPU 977; FIG. 9B). The HIPD 900 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 900 can perform the above operations alone or in conjunction with a wearable device (or other communicatively coupled electronic device).

FIG. 9B shows block diagrams of a computing system 940 of the HIPD 900, in accordance with some embodiments. The HIPD 900, described in detail above, can include one or more components shown in HIPD computing system 940. The HIPD 900 will be understood to include the components shown and described below for the HIPD computing system 940. In some embodiments, all, or a substantial portion of the components of the HIPD computing system 940 are included in a single integrated circuit. Alternatively, in some embodiments, components of the HIPD computing system 940 are included in a plurality of integrated circuits that are communicatively coupled.

The HIPD computing system 940 can include a processor (e.g., a CPU 977, a GPU, and/or a CPU with integrated graphics), a controller 975, a peripherals interface 950 that includes one or more sensors 951 and other peripheral devices, a power source (e.g., a power system 995), and memory (e.g., a memory 978) that includes an operating system (e.g., an operating system 979), data (e.g., data 988), one or more applications (e.g., applications 980), and one or more modules (e.g., a communications interface module 981, a graphics module 982, a task and processing management module 983, an interoperability module 984, an AR processing module 985, a data management module 986, etc.). The HIPD computing system 940 further includes a power system 995 that includes a charger input and output 996, a PMIC 997, and a battery 998, all of which are defined above.

In some embodiments, the peripherals interface 950 can include one or more sensors 951. The sensors 951 can include analogous sensors to those described above in reference to FIG. 7B. For example, the sensors 951 can include imaging sensors 954, (optional) EMG sensors 956, IMUs 958, and capacitive sensors 960. In some embodiments, the sensors 951 can include one or more pressure sensor 952 for sensing pressure data, an altimeter 953 for sensing an altitude of the HIPD 900, a magnetometer 955 for sensing a magnetic field, a depth sensor 957 (or a time-of flight sensor) for determining a difference between the camera and the subject of an image, a position sensor 959 (e.g., a flexible position sensor) for sensing a relative displacement or position change of a portion of the HIPD 900, a force sensor 961 for sensing a force applied to a portion of the HIPD 900, and a light sensor 962 (e.g., an ambient light sensor) for detecting an amount of lighting. The sensors 951 can include one or more sensors not shown in FIG. 9B.

Analogous to the peripherals described above in reference to FIG. 7B, the peripherals interface 950 can also include an NFC component 963, a GPS component 964, an LTE component 965, a Wi-Fi and/or Bluetooth communication component 966, a speaker 969, a haptic device 971, and a microphone 973. As described above in reference to FIG. 9A, the HIPD 900 can optionally include a display 968 and/or one or more buttons 967. The peripherals interface 950 can further include one or more cameras 970, touch surfaces 972, and/or one or more light emitters 974. The multi-touch input surface 902 described above in reference to FIG. 9A is an example of touch surface 972. The light emitters 974 can be one or more LEDs, lasers, etc. and can be used to project or present information to a user. For example, the light emitters 974 can include light indicators 912 and 926 described above in reference to FIG. 9A. The cameras 970 (e.g., cameras 914A, 914B, and 922 described above in FIG. 9A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 970 can be used for SLAM; 6 DoF ray casting, gaming, object manipulation, and/or other rendering; facial recognition and facial expression recognition, etc.

Similar to the watch body computing system 760 and the watch band computing system 730 described above in reference to FIG. 7B, the HIPD computing system 940 can include one or more haptic controllers 976 and associated componentry (e.g., haptic devices 971) for providing haptic events at the HIPD 900.

Memory 978 can include high-speed random-access memory and/or non-volatile memory, such as one or more magnetic disk storage devices, flash memory devices, or other non-volatile solid-state memory devices. Access to the memory 978 by other components of the HIPD 900, such as the one or more processors and the peripherals interface 950, can be controlled by a memory controller of the controllers 975.

In some embodiments, software components stored in the memory 978 include one or more operating systems 979, one or more applications 980, one or more communication interface modules 981, one or more graphics modules 982, one or more data management modules 985, which are analogous to the software components described above in reference to FIG. 7B.

In some embodiments, software components stored in the memory 978 include a task and processing management module 983 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 983 uses data 988 (e.g., device data 990) to distribute the one or more front-end and/or back-end tasks based on communicatively coupled devices' computing resources, available power, thermal headroom, ongoing operations, and/or other factors. For example, the task and processing management module 983 can cause the performance of one or more back-end tasks (of an operation performed at communicatively coupled AR device 800) at the HIPD 900 in accordance with a determination that the operation is utilizing a predetermined amount (e.g., at least 70%) of computing resources available at the AR device 800.

In some embodiments, software components stored in the memory 978 include an interoperability module 984 for exchanging and utilizing information received and/or provided to distinct communicatively coupled devices. The interoperability module 984 allows for different systems, devices, and/or applications to connect and communicate in a coordinated way without user input. In some embodiments, software components stored in the memory 978 include an AR module 985 that is configured to process signals based at least on sensor data for use in an AR and/or VR environment. For example, the AR processing module 985 can be used for 3D object manipulation, gesture recognition, facial and facial expression, recognition, etc.

The memory 978 can also include data 987, including structured data. In some embodiments, the data 987 can include profile data 989, device data 989 (including device data of one or more devices communicatively coupled with the HIPD 900, such as device type, hardware, software, configurations, etc.), sensor data 991, media content data 992, and application data 993.

It should be appreciated that the HIPD computing system 940 is an example of a computing system within the HIPD 900, and that the HIPD 900 can have more or fewer components than shown in the HIPD computing system 940, combine two or more components, and/or have a different configuration and/or arrangement of the components. The various components shown in HIPD computing system 940 are implemented in hardware, software, firmware, or a combination thereof, including one or more signal processing and/or application-specific integrated circuits.

The techniques described above in FIG. 9A-9B can be used with any device used as a human-machine interface controller. In some embodiments, an HIPD 900 can be used in conjunction with one or more wearable device such as a head-wearable device (e.g., AR device 800 and VR device 810) and/or a wrist-wearable device 700 (or components thereof).

### Drawbacks of Example Display Panels and Display Engines

Additional example visual feedback mechanisms include Red-Green-Blue (RGB) display panels. Fabrication of RGB display panels with smaller than 5 μm pixel pitch to meet form factor constraints can be challenging due to the differences in light emitting diode (LED) materials. For example, the base material composition for fabricating red LEDs is different than the base material composition for fabricating green and/or blue LEDs and, as such, RGB LED pixels are traditionally fabricated separately and then assembled into a pixel with R, G, B subpixels. This results in a larger pixel size (for example 10 μm). Thus, high pixel per degree augmented-reality displays with larger field-of-views result in a large display panel size, which may be difficult to fit within some glasses form factors.

In some embodiments, liquid crystal on silicon (LCOS) display engines with polarization-based optical combiners are limited by liquid crystal response to electrical field that result in pixel size limitation and constraints to the form factor of augmented-reality glasses.

Scanning mirror display engines take a single light source, or light source linear array, utilizing a one-axis or two-axis scanning mirror system, to generate square or rectangular field-of-view (FOV) outputs. However, scanning mirror systems are bulky and require extra power to drive the moveable parts. Display engines with X-cube combiners have low optical efficiencies and high variations in FOV outputs to meet the FOV requirements of augmented-reality display systems. Additionally, X-cube combiners are normally bulky and heavy.

### Examples of Improved Display Panels and/or Display Engines

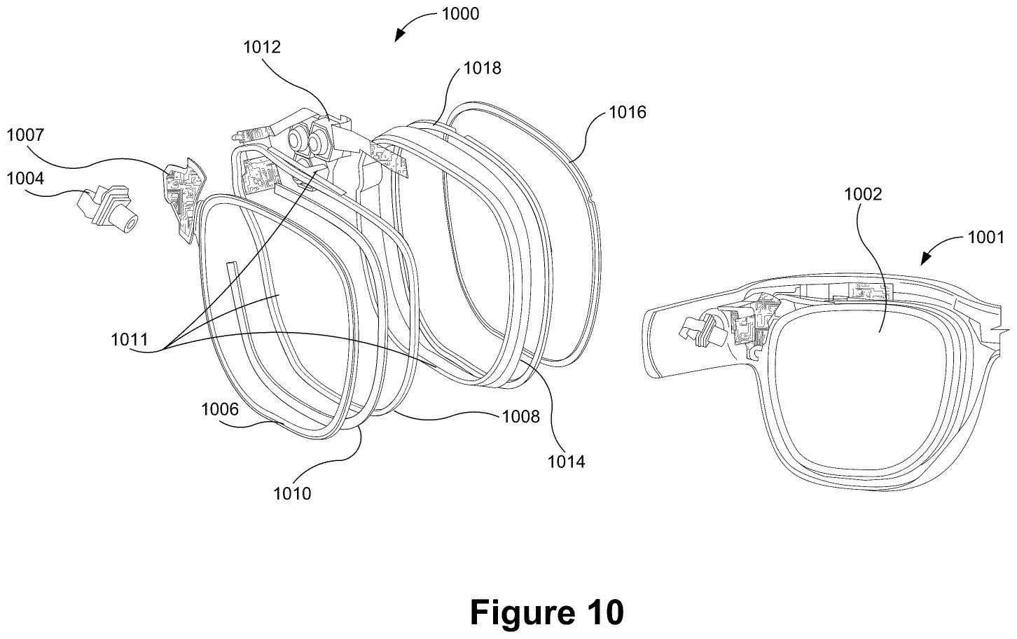

FIG. 10 illustrates the projector and lens assembly used in an augmented-reality headset, in accordance with some embodiments. One skilled in the art will appreciate the components described in reference to FIG. 10 can be substituted or added to the augmented-reality headset described in reference to FIGS. 1-5. FIG. 10 shows an exploded view 1000 of a projector and lens assembly 1002 which is configured for use in an augmented-reality headset 1001 (e.g., or optionally in augmented-reality headset 100 in FIGS. 1-5). FIG. 10 shows in the exploded view 1000 a plurality of components for facilitating the presentation of an augmented-reality experience (e.g., the display of an augment interface element). Moving from left to right (i.e., from the wearer's face to the outside environment) in the exploded view 1000, the exploded view 1000 shows an eye tracking camera module 1004 for tracking movement of an eye of a wearer, where the data from the eye-tracking camera can be used for interacting with an augmented-reality experience. As discussed earlier, the eye-tracking camera module 1004 is not facing the wearer's eye and instead tracks the movement of the wearer's eye indirectly from reflections of the eye at lens 1006. In some embodiments, the lens 1006 includes a circuit 1007 that includes circuitry that is associated with the display projector assembly 1012 and/or circuitry for routing and conveying information between electronics in a temple arm of the augmented-reality headset and electronics in the frame and/or display projection assemblies.

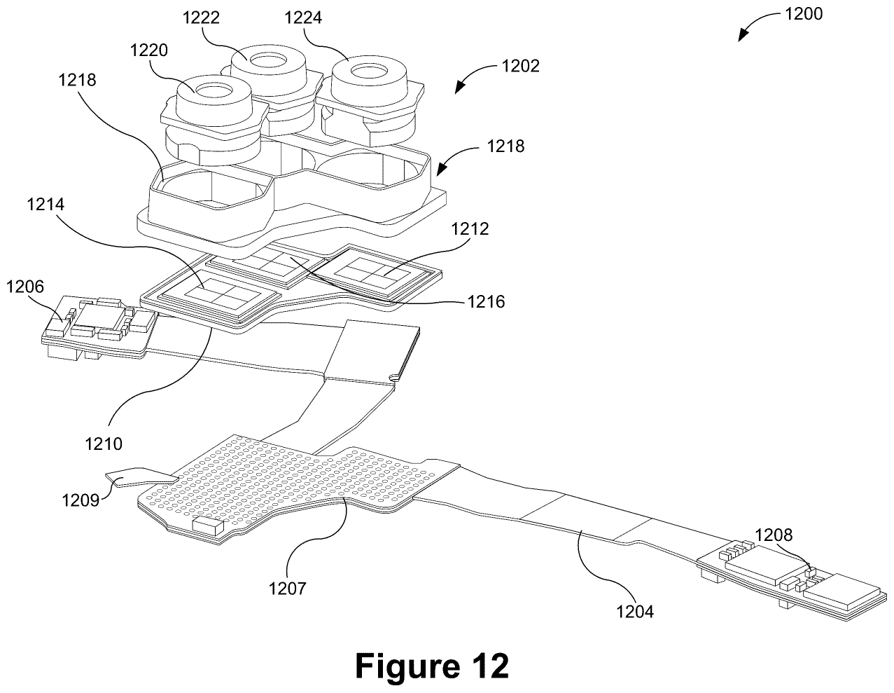

The lens 1006 is separated from the waveguide 1008 by a bumper 1010 that is used to isolate the waveguide 1008 from the lens 1006. As discussed in reference to FIG. 3, the waveguide can include one or more flexures with tabs 1011 that secure the waveguide to the frame. The waveguide 1008 is configured to receive image projections from a display projector assembly 1012 (discussed in further detail in reference to FIG. 12), such that an augmented-reality image is displayed to the wearer.

A larger bumper 1014 separates the waveguide 1008 from another lens 1016, and the bumper, as discussed in reference to FIG. 1 can be dual purpose, e.g., (i) reducing vibrations/impact forces to the waveguide and (ii) being a cosmetic cover for the surround internal electronics of the augmented reality headset 1001. In some embodiments, the larger bumper 1014 can interface with or be integrally formed with an additional bumper 1018 placed between the bumper 1014 and the other lens 1016. This additional bumper 1018, in some embodiments, is comprised of the same material as the bumper 1010. In some embodiments, the bumper 1010 and the additional bumper 1018 are comprised of a different material than the larger bumper 1014. In some embodiments, the bumpers are glued in placed to secure them in the correct orientations relative to the lenses and waveguides.

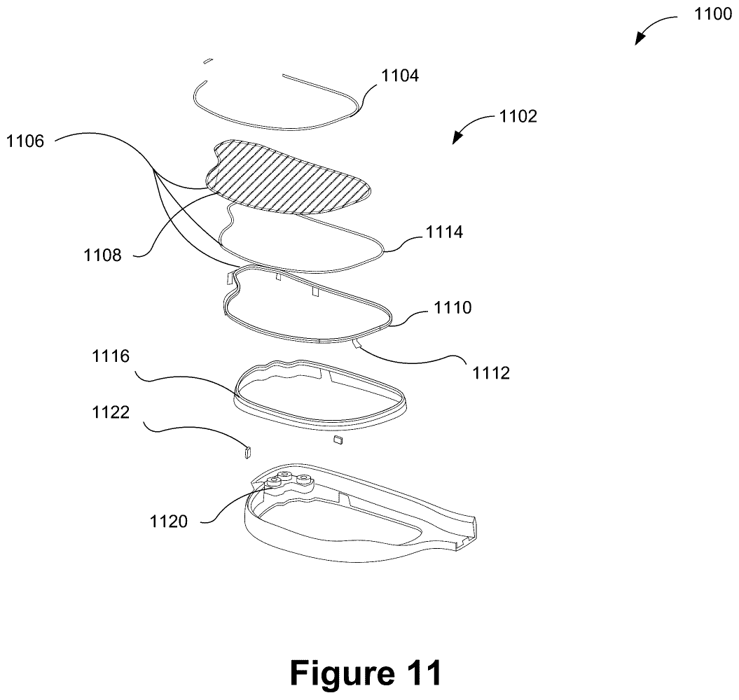

FIG. 11 illustrates a partial exploded view of a display projector and lens assembly, in accordance with some embodiments. One skilled in the art will appreciate the components described in reference to FIG. 11 can be substituted or added to the augmented-reality headset described in reference to FIGS. 1-5 and 10. Moving from top down, FIG. 11 shows another exploded view 1100 providing additional details regarding the projector and lens assembly 1102. As shown, the projector and lens assembly 1102 includes a bumper 1104 (analogous to bumper 1010 in FIG. 10). As discussed elsewhere the bumper 1104 restricts waveguide travel during impacts and/or reducing other vibrations in non-impact (e.g., non-drop) events. In some embodiments, the bumper 1104 is multiple parts, which can be useful for assembly. In some embodiments, the bumper 1104 can have a certain shape and length to accommodate other electronics of the augmented-reality headset (e.g., display projection assembly 1120). The bumper 1104 attaches to the waveguide 1106 via an adhesive and/or fiction fit.

The waveguide 1106, in this embodiment, comprises at least: (i) a silicon carbide waveguide 1108 which in some embodiments includes one or more hydrophobic coatings (e.g., optically clear or tinted hydrophobic coatings), (ii) a titanium carrier 1110 that distributes loads uniformly to improve handling and integration, (iii) titanium flexures 1112, as discussed in detail elsewhere, that are quasi-kinematic mounts for the waveguide, and (iv) an adhesive 1114 for securing the waveguide to the titanium carrier 1110. In some embodiments, the waveguide can be comprised of other materials and the hydrophobic coatings can be optional. In some embodiments, the material choice for the carrier and the flexures can include other alloys, composites, and other suitable materials.

FIG. 11 shows a larger bumper 1116 (analogous to bumper 1014 shown in FIG. 10 and front bumpers 126A and 126B shown in FIG. 1) that, in some embodiments, is bonded to the titanium carrier 1110 to isolate its position relative to the remaining components of projector and lens assembly. In some embodiments, the larger bumper 1116 can be comprised of multiple materials, e.g., a more rigid plastic that is overmolded by a rubber/silicone material, such that the larger waveguide 1116 maintains its shape while still providing dampening. As discussed elsewhere, the titanium flexures 1112 secure the waveguide assembly to the frame 1118 via being inserted into glue wells (e.g., as illustrated by adhesive 1122).

In some embodiments, there is asymmetry between lens stacks. Alternatively, or in addition, corresponding lens stack design details can take into consideration asymmetry between lens stacks. For example, lens stacks can also take into consideration differences between emission characteristic of a green LED panel versus red and/or blue LED panels.

FIG. 12 illustrates an exploded view 1200 of a display projector assembly 1202 used in an augmented-reality headset, such as those shown in the preceding figures, in accordance with some embodiments. The projector assembly described in FIG. 12 is analogous to display projector assemblies 116A and 116B in FIG. 1, display projector assembly 1012 in FIG. 10, and display projector 1120 shown in FIG. 11.

Moving from the bottom upward, FIG. 12 shows a PCB 1204 that includes a plurality of electronic components for controlling the display project assembly 1202. For example, the PCB 1204 includes (i) an integrated circuit 1206 for controlling the display projector assembly, (ii) a solder pad 1207 configured to accept an array of microLEDs 1210, and (iii) one or more components 1208 for providing power to the display projector assembly 1202. The PCB is also configured to couple with a desense pad 1209 for controlling radio frequency interference. As mentioned, the PCB is coupled to an array of microLED 1210 that outputs light to the waveguide for presentation of an augmented-reality experience. The microLEDs can be as small as 1 micrometers, and can range between 1-5 micrometers based on the application and price point. The microLED can include an array of blue microLEDs 1212, an array of green microLEDs 1214, and an array red microLEDs 1216. In some embodiments, a single-color LED (e.g., green) can be used to reduce cost, the size of the microLEDs may also be increased (e.g., greater than 5 micrometers) to reduce cost, thereby producing a low-fidelity display.

Placed on top of the microLEDs is a lens holder assembly 1218 that is configured to hold at least three lenses, where each lens holder of the lens holder assembly 1218 corresponds to the three arrays of microLEDs (e.g., an array of blue microLEDs 1212, an array of green microLEDs 1214, and an array red microLEDs 1216). In some embodiments, the lens holder assembly comprises an liquid crystal polymer (LCP), as it has a lower thermal expansion compared to other plastics. Minimizing the thermal expansion reduces color channel disparity between the microLED assemblies located on each side of the augmented-reality headset.

The lens holder assembly 1218 is configured to hold three collimators 1220-1224, each of which correspond to one of the three arrays of microLEDs (e.g., an array of blue microLEDs 1212, an array of green microLEDs 1214, and an array red microLEDs 1216). The light outputs from the collimators 1220-1224 are provided to a waveguide (e.g., waveguide 122A or 122B in FIG. 1, waveguide 301 shown in FIG. 3, waveguide 1008 in FIG. 10, and waveguide 1108 in FIG. 11). In some embodiments, the waveguide includes interface areas (e.g., in-coupling optical elements) that are configured to receive the light emitted by the three collimators 1220-1224. In some embodiments, the collimators are able to provide a 20% brightness gain with lower resolutions. When corresponding microLEDs from each of the array of blue microLEDs 1212, the array of green microLEDs 1214, and the array red microLEDs 1216 are activated, a white color is achieved (e.g., a white crosshair pixel). In some embodiments, a two-micron red, blue, green LED can produce a two-micron white pixel LED (e.g., the combined white light can be the same size as an individual microLED). In some embodiments, a three panel microLEDs require aligning the RGB pixels together during manufacturing such that the microLEDs are calibrated correctly. In some embodiments, post-calibration is possible using software after production has occurred to account for differences in production tolerances. In some embodiments, the microLEDs have a small pixel finish, such as 5 microns or less, which allow for a high-resolution image to be provided to the wearer.

In some embodiments, a pupil location can be measured using an ET (eye tracking) system and/or color correction tables from different pupil locations that are down-sampled by 16×or 32×and stored to the device. To cover the whole population, 4×4 or 5×5 correction tables corresponding to different discrete pupil locations are stored on the device to cover different pupil locations. This combination allows for a white image to be placed in an eye-box location corresponding to a wearer. In some embodiments, this location can be tuned statically (e.g., by adjusting the mechanical design) and/or dynamically (e.g., using software to perform on-the-fly calibrations/corrections based on pupil location provided by the ET (eye tracking) system). In some embodiments, uniformity corrections can occur on a frame-by-frame basis, ensuring constant image quality.

Pointing error between the three LED colors needs to be well controlled. In some embodiments, extra microLED pixels are used for post-assembly pointing error compensation. In some embodiments, the display projector assembly 1202 is configured to perform an active alignment process for different pixel size requirements, such as requirements from 5 μm, 2.5 μm, 2 μm.

In some embodiments, the display projector assembly 1202 has a predetermined power consumption (e.g., 100 mW), predetermined mechanical package size (e.g., 2 mm×2 mm), and/or predetermined pixel/degree resolution (e.g., 13, 26, 30, 36 pixel per degree).

In some embodiments, one or more components are removed from the back of PCB 1204 (e.g., a rigid-flex printed circuit) to enable more thermal contact area and smaller Z height.

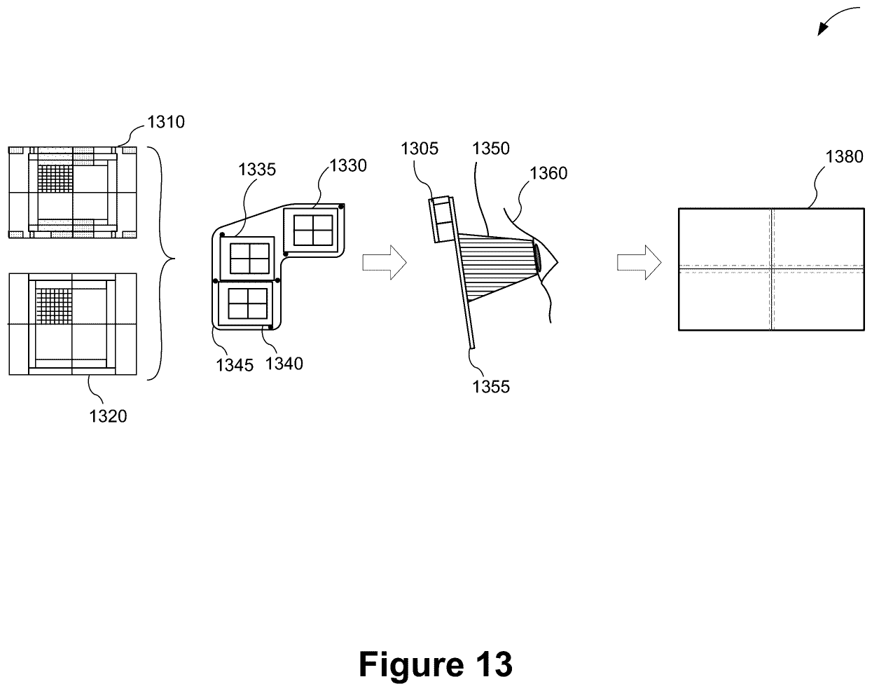

FIG. 13 shows an example display projector assembly, in accordance with some embodiments. In some embodiments, the display projector assembly has a display engine or projector 1305 that includes a microLED circuit 1310 bonded with a microLED semiconductor array 1320 to form a microLED panel. For example, the microLED circuit 1310 is bonded to the microLED semiconductor array 1320 to form a microLED panel (e.g., 1330, 1335, and 1340) emitting one or more colors. The display engine or projector 1305 forms the image(s) for augmented-reality display using at least one microLED panel. In some embodiments, the display engine (sometimes referred to as a display projector) includes some or all of the components of the display projector assembly 116A and 116B described with respect to FIG. 1. In some embodiments, light from the microLED panel (e.g., 1330, 1335, 1340) is optically coupled into a display waveguide 1355, with one or more optical in-coupling and out-coupling elements, to cause display of augmented-reality content 1350 to an eye 1360 of a wearer of the augmented-reality glasses.

In some embodiments, the one or more optical in-coupling and out-coupling elements are optical gratings, optical couplers, prism couplers, holographic optical elements, and/or optical metasurface elements that control a propagation direction and/or polarization state of light.

In some embodiments, the microLED circuit 1310 is a driver circuit and the microLED semiconductor array 1320 is a one-dimensional or two-dimensional array of microLEDs arranged on a common plane. In some embodiments, the microLED circuit 1310 is electrically coupled and/or bonded to the microLED semiconductor array 1320 to form the microLED panel.

In some embodiments, each of the microLED panels (e.g., 1330, 1335, 1340) is a monochrome light emitting panel that generates images of one color. For example, the microLED panel 1335 has LEDs that emit light centered in the red wavelength spectrum and the images generated by the microLED panel 1335 are red. As another example, the microLED panel 1340 has LEDs that emit light centered in the green wavelength spectrum and the images generated by the microLED panel 1335 are green. As another example, the microLED panel 1330 has LEDs that emit light centered in the blue wavelength spectrum and the images generated by the microLED panel 1335 are blue. The microLED panels are arranged as described above with respect to FIG. 12 and positioned on a common substrate 1345 to generate three-channel display images, each channel respectively corresponding to one color (e.g., red, green, blue, etc.). In some embodiments, the common substrate 1345 is less than 12 mm×14 mm. In some embodiments, each microLED panel has dimensions that are less than 5 mm (e.g., per edge). For example, microLED panel 1335 is less than or equal to 4 mm×4 mm with a height that is less than 1.05 mm and more than 0.5 mm.

In some embodiments, the display waveguide 1355 is a three-channel waveguide combiner that maintains angular alignment of the three channels. In some embodiments, the display waveguide 1355 is a three-channel waveguide combiner that enables three-color-mixing via out-coupling and overlaying three guided optical modes, each mode corresponding to a respective color. For example, the three-channel waveguide combiner is an optical chip with three waveguides that respectively guide light of one of the primary colors (red, green, or blue) while maintaining an angular alignment for the optical mode propagating in the respective waveguide. Maintaining the angular alignment enables proper coupling of the collimated light from the microLED panels into the three-channel waveguide 1355 via the in-coupling element and accurate out-coupling of the respective optical mode from the display waveguide 1355 towards the eye of the user. In some embodiments, the display waveguide 1355 is a planar waveguide. In some embodiments, the display waveguide 1355 is a strip or ridge waveguide. In some embodiments, the display waveguide 1355 has three single-mode waveguides that respectively guide light of one of three colors. Additionally, or alternatively, the display waveguide 1355 has multi-mode waveguides that are configured as a three-channel waveguide combiner.

In some embodiments, the display waveguide 1355 provides pupil replication within the waveguide and the three-channel display images are overlaid to generate white images and/or images of desired colors. For example, the overlaid three-color images that include display images of red, green, and blue colors are mixed to form desired multi-colored display images for display to the wearer of the augmented-reality glasses. In some embodiments, an image 1380 seen by a wearer of the augmented-reality glasses is an overlaid composite image generated by the three-channel display waveguide 1355 with each contributing image corresponding to one color and one channel of the display waveguide 1355. The image 1380 shows intentional mis-alignment between the three display images for illustrative visualization purposes.

By using three separate RGB microLED panels (e.g., 1330, 1335, 1340) the display engine or projector 1305 generates light of three different colors that are focused/collimated to create three separate optical paths. The three optical paths couple into the three-channel waveguide (display waveguide 1355) that projects, after pupil replication, separate R-G-B colored field-of-views overlaid to create the desired color images.

Additionally or alternatively, the display waveguide 1355 is a multi-channel waveguide that enables color-mixing for two or more colors. For example, the display waveguide 1355 is a two-channel waveguide with each waveguide guiding at least one optical mode corresponding to a particular color.

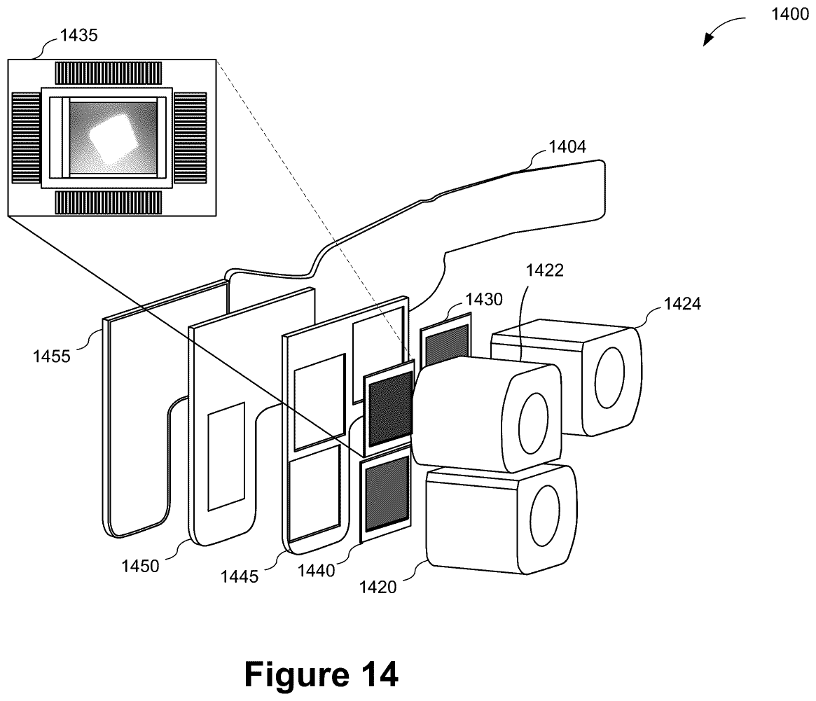

FIG. 14 shows an example illustration of microLED panels assembled with optical components, in accordance with some embodiments. In some embodiments, one or more panels (e.g., panels 1455, 1450, and 1445) have LED driver circuits and/or supporting structures for mounting the microLED arrays (e.g., 1430, 1435, and 1440). In some embodiments, each panel of the one or more panels is configured to drive and/or mount a corresponding microLED array as described with respect to FIGS. 12 and 13 described above. In some embodiments, each microLED array is optically aligned with and coupled to one or more optical components (e.g., 1420, 1422, 1424). For example, the one or more optical components are collimation and/or focusing optical elements for coupling light emitted from the corresponding microLED array into the display waveguide 1355 described above with respect to FIG. 13.

In some embodiments, the three separate monochrome microLED panels with separate projector optical paths enable fabrication of pixel pitch sizes of less than 5 μm (e.g., 1.5 μm, 2 μm, 2.5 μm, 3 μm, 4 μm, 4.5 μm, etc.). By fabricating reduced form factor display panels with pixel pitch sizes of less than 5 μm, the display projector assembly can provide a large FOV (e.g., at or larger than 40×30 degrees) at very small form factors and with high pixel per degree resolution (e.g., 10, 15, 18, 20, 22, 24, 25, etc.). In some embodiments, the display engine with the three separate monochrome microLED panels has a low power consumption of less than 400 mW. In some embodiments, a total radiant flux of the display engine with the three separate monochrome microLED panels is less than 400 mW per eye.

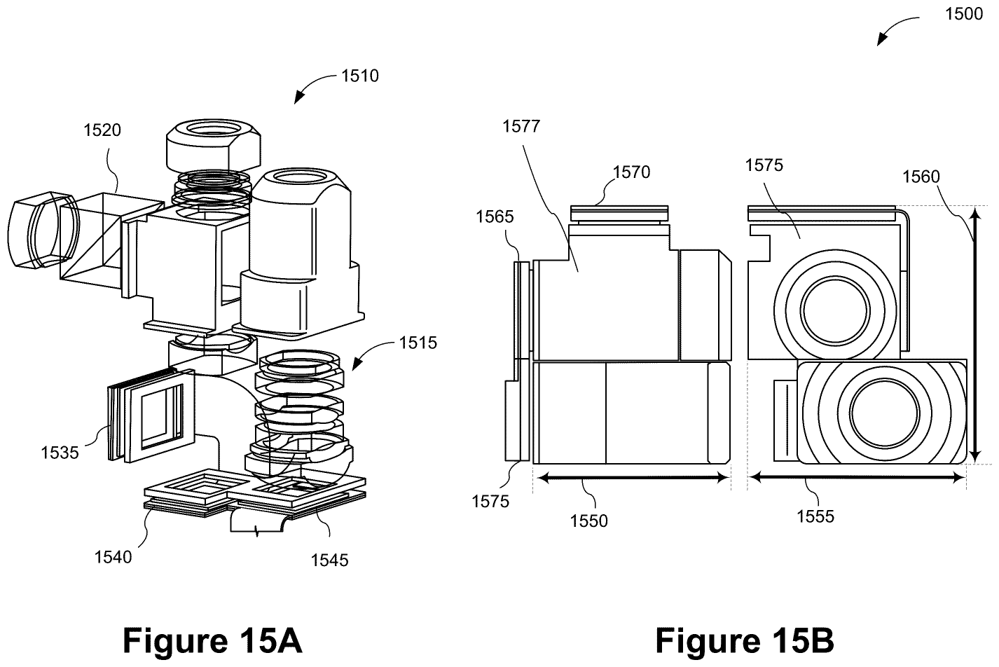

FIGS. 15A and 15B show example illustrations of exploded views of one or more optical components optically coupled to microLED panels, in accordance with some embodiments. FIG. 15A shows exploded views of the one or more optical elements coupled to the microLED panels (similar to the microLED panels described above with respect to FIGS. 13 and 14). In some embodiments, the microLED panels (e.g., 1535, 1540, and 1545) are optically aligned with and coupled to collimation and/or focusing optical assemblies 1515 and/or optical assembly housing 1510 (e.g., barrels, covers, etc.). In some embodiments, a dichroic cube 1520 is part of the one or more optical components couped to the microLED panels. In some embodiments, a height of the microLED panels is less than 1 mm. In some embodiments, a height of the housing for the collimation optics and/or focusing optics is less than 5 mm. In some embodiments, a total height of the projector assembly (e.g., the collimation optics and the microLED panels) is less than 6.5 mm.

FIG. 15B shows side-views one or more optical elements for a display projector assembly, in accordance with some embodiments. In some embodiments, the one or more optical elements include microLED arrays 1565, 1570, and 1575 and optical housing elements (e.g., 1575, 1577). In some embodiments, the optical housing elements have a first dimensional length 1550 that is more than 5 mm and less than 11 mm. For example, the microLED array 1570 is a red microLED array. As another example, the microLED array 1565 is a blue microLED array. As another example, the microLED array 1575 is a green microLED array. In some embodiments, the optical housing elements have a second dimensional length 1560 that is more than 5 mm and less than 13 mm.

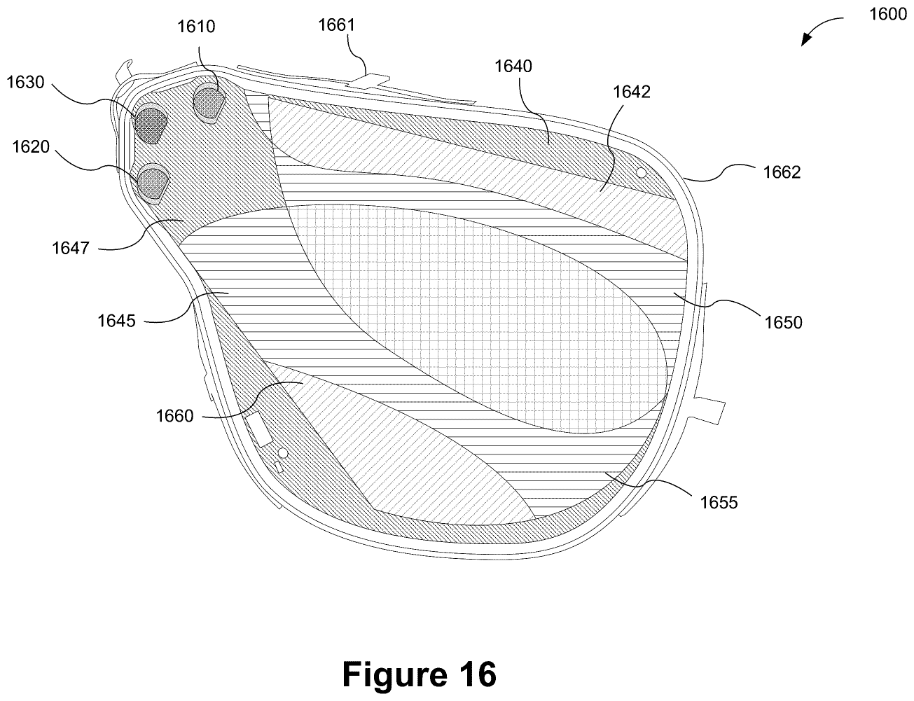

FIG. 16 shows an example illustration of a display lens, in accordance with some embodiments. In some embodiments, the display lens 1600 includes display waveguide(s) 1647 (such as the three-channel waveguide combiner 1355, the waveguides 122A and 122B described with respect to FIG. 1, the waveguide 301 in FIG. 3, and the waveguide(s) 502 in FIG. 5), in-coupling optical elements, expansion/out-coupling optical elements, and recycling optical elements (e.g., 1610, 1620, 1630), supporting elements (e.g., frames 1662, brackets, bumpers 1661, etc.) and/or assembly elements (fasteners, adhesives, etc.). The in-coupling and out-coupling optical elements can be similar to those described above with respect to FIG. 13.

In some embodiments, the display waveguide(s) 1647 portion of the display lens 1600 has a plurality of waveguiding regions (e.g., 1640, 1642, 1645, 1650, 1655, and/or 1660) that form a part of the three-channel waveguide combiner as described above with respect to FIG. 13. In some embodiments, one or more of the plurality of waveguiding regions include out-coupling optical elements for directing the guided light modes from the three-channel waveguide combiner towards an eye of a wearer of the augmented-reality glasses. In some embodiments, the one or more of the plurality of waveguiding regions form the pupil replication region and include the out-coupling optical elements for directing the guided light modes towards the eye of the wearer. In some embodiments, the pupil replication region is an exit pupil region. In some embodiments, the one or more of the plurality of waveguiding regions include one or more pupil replication or exit pupil regions. For example, a first waveguiding portion has a pupil replication and exit pupil region within the out-coupling optical element 1645/1650. For better fitment and population coverage, light out-couples towards a region where most users' eye pupils locate relative to the waveguide (e.g., 15 mm from the waveguide surface in the z-direction, and 16×12 mm\hat{ }2 in x-dimension and/or y-dimension to cover majority of population). In some embodiments, the in-coupling optical element 1610 in-couples augmented-reality display images corresponding to the red guided optical mode. In some embodiments, the in-coupling optical element 1620 in-couples augmented-reality display images corresponding to the blue guided optical mode. In some embodiments, the in-coupling optical element 1630 in-couples augmented-reality display images corresponding to the green guided optical mode.

Alternatively, the plurality of waveguiding regions (e.g., 1640, 1642, 1645, 1650, 1655, and/or 1660) form a part of a multi-channel waveguide combiner (e.g., two-channel, four-channel, etc.) that overlay the guided light modes for display of augmented-reality content to a user. For example, the plurality of waveguiding regions form a part of a two-channel waveguide combiner that guides light of two colors.
(G1) In accordance with some embodiments, an augmented-reality glasses (e.g., an augmented-reality headset, as shown in FIGS. 1-6B, 8A-8C, and 10-16 is configured to display an extended reality, including a mixed reality, a virtual reality, etc.) comprises a plurality of panels of light emitters arranged to form an array of light emitters, wherein the array of light emitters includes light emitters generating three colors; collimation optics for collimating light received from the array of light emitters; an optical coupler for receiving the collimated light; and a three-channel waveguide combiner for display of augmented-reality content to a wearer of the augmented-reality glasses, wherein each channel of the three-channel waveguide combiner respectively causes display of images of one color of the three colors generated by the light emitters.
(G2) In some embodiments, each channel of the three-channel waveguide combiner maintains a respective angular alignment for each color of the three colors. For example, each channel of the three-channel waveguide combiner maintains a respective angular alignment for a respective mode of the R-G-B guided modes.
(G3) In some embodiments, the three-channel waveguide combiner is an optical waveguide with pupil replication. For example, the three-channel waveguide combiner has out-coupling optical elements that provide pupil replication and form at least one exit pupil region. In some embodiments, the three-channel waveguide combiner has an exit pupil region that respectively corresponds to each channel.
(G4) In some embodiments, the optical coupler is an in-coupling optical element for coupling the collimated light into the three-channel waveguide combiner. For example, the in-coupling optical element is a grating, holographic optical element, metasurface element, etc.
(G5) In some embodiments, the collimation optics provides an optical magnification of at least three. For example, the collimation optics 1515 provides a magnification of 2× up to 4×.
(G6) In some embodiments, the collimation optics have a height of more than 4 mm and less than 7 mm. For example, the collimation optics 1515 with the housing (e.g., 1577 of FIG. 15B) have a height that is less than 7 mm and more than 4 mm.
(G7) In some embodiments, the array of light emitters is a two-dimensional array of light emitters arranged on a common plane and the array of light emitters is characterized by a pitch that is less than 2 μm. For example, the pixel pitch for the array of light emitters (e.g., 1212, 1214, and 1216 of FIG. 12, 1335, 1330, and 1345 of FIG. 13, 1430, 1435, and 1440 of FIG. 14, and 1535, 1540, and 1545 of FIG. 15A) is 1.8 μm. In some embodiments, the array of light emitters is characterized by a pixel pitch that is less than 5 μm and greater than 1.5 μm.
(G8) In some embodiments, each light emitter of the two-dimensional array of light emitters has a diameter that is equal to or less than 2 μm and the plurality of panels of light emitters has a thickness less than 1 mm. For example, the microLED panels (e.g., 1335, 1330, 1345 of FIG. 13) have a thickness that is more than 0.4 mm and less than 1 mm. In some embodiments, the microLED panels with the supporting common substrate 1345 have a thickness that is more than 0.4 mm and less than 1 mm.
(H1) In accordance with some embodiments, a display projector assembly has a plurality of panels of light emitters arranged to form an array of light emitters, wherein the array of light emitters includes light emitters generating three colors; collimation optics for collimating light received from the array of light emitters; an optical coupler for receiving the collimated light; and a three-channel waveguide combiner for display of augmented-reality content to a wearer of the augmented-reality glasses, wherein each channel of the three-channel waveguide combiner respectively causes display of images of one color of the three colors generated by the light emitters.
(H2) In some embodiments, each channel of the three-channel waveguide combiner maintains a respective angular alignment for each color of the three colors.
(H3) In some embodiments, the three-channel waveguide combiner is an optical waveguide with pupil replication.
(H4) In some embodiments, the optical coupler is an in-coupling optical element for coupling the collimated light into the three-channel waveguide combiner.
(H5) In some embodiments, the collimation optics provides an optical magnification of at least three.
(H6) In some embodiments, the collimation optics have a height of less than 7 mm.
(H7) In some embodiments, the array of light emitters is a two-dimensional array of light emitters arranged on a common plane and the array of light emitters is characterized by a pitch that is less than 2 μm.
(I1) In accordance with some embodiments, a method of assembling augmented-reality glasses includes: forming a display projector assembly that has (i) a plurality of panels of light emitters arranged to form an array of light emitters, wherein the array of light emitters includes light emitters generating three colors; (ii) collimation optics for collimating light received from the array of light emitters; and (iii) a three-channel waveguide combiner, wherein each channel of the three-channel waveguide combiner respectively causes display of images of one color of the three colors generated by the light emitters; and optically aligning the collimating optics with the three-channel waveguide combiner for causing display of augmented-reality content to a wearer of the augmented-reality glasses.
(I2) In some embodiments, forming the projector assembly further includes any of (G2)-(G8).

One skilled in the art would appreciate that the components described in FIGS. 13-16 provide additional specificity for the components described in reference to FIGS. 1-5 and FIGS. 10-12.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An augmented-reality glasses, comprising:
a plurality of panels of light emitters arranged to form an array of light emitters, wherein the array of light emitters includes light emitters generating three colors;
collimation optics for collimating light received from the array of light emitters;
an optical coupler for receiving the collimated light; and
a three-channel waveguide combiner for display of augmented-reality content to a wearer of the augmented-reality glasses, wherein each channel of the three-channel waveguide combiner respectively causes display of images of one color of the three colors generated by the light emitters.

2. The augmented-reality glasses of claim 1, wherein each channel of the three-channel waveguide combiner maintains a respective angular alignment for each color of the three colors.

3. The augmented-reality glasses of claim 1, wherein the three-channel waveguide combiner is an optical waveguide with pupil replication.

4. The augmented-reality glasses of claim 1, wherein the optical coupler is an in-coupling optical element for coupling the collimated light into the three-channel waveguide combiner.

5. The augmented-reality glasses of claim 1, wherein the collimation optics provides an optical magnification of at least three.

6. The augmented-reality glasses of claim 1, wherein the collimation optics have a height of less than 7 mm.

7. The augmented-reality glasses of claim 1, wherein the array of light emitters is a two-dimensional array of light emitters arranged on a common plane and the array of light emitters is characterized by a pitch that is less than 2 μm.

8. The augmented-reality glasses of claim 1, wherein each light emitter of the two-dimensional array of light emitters has a diameter that is less than 2 μm and the plurality of panels of light emitters has a thickness less than 1 mm.

9. A display projector assembly, comprising:
a plurality of panels of light emitters arranged to form an array of light emitters, wherein the array of light emitters includes light emitters generating three colors;
collimation optics for collimating light received from the array of light emitters;
an optical coupler for receiving the collimated light; and
a three-channel waveguide combiner for display of augmented-reality content to a wearer of the augmented-reality glasses, wherein each channel of the three-channel waveguide combiner respectively causes display of images of one color of the three colors generated by the light emitters.

10. The display projector assembly of claim 9, wherein each channel of the three-channel waveguide combiner maintains a respective angular alignment for each of the three colors.

11. The display projector assembly of claim 9, wherein the three-channel waveguide combiner is an optical waveguide with pupil replication.

12. The display projector assembly of claim 9, wherein the optical coupler is an in-coupling optical element for coupling the collimated light into the three-channel waveguide combiner.

13. The display projector assembly of claim 9, wherein the collimation optics provides an optical magnification of at least three.

14. The display projector assembly of claim 9, wherein the collimation optics have a height of less than 7 mm.

15. The display projector assembly of claim 9, wherein the array of light emitters is a two-dimensional array of light emitters arranged on a common plane and the array of light emitters is characterized by a pitch that is less than 2 μm.

16. The display projector assembly of claim 9, wherein each light emitter of the two-dimensional array of light emitters has a diameter that is less than 2 μm and the plurality of panels of light emitters has a thickness less than 1 mm.

17. A method of assembling augmented-reality glasses, comprising:
forming a display projector assembly comprising:
a plurality of panels of light emitters arranged to form an array of light emitters, wherein the array of light emitters includes light emitters generating three colors;
collimation optics for collimating light received from the array of light emitters; and
a three-channel waveguide combiner, wherein each channel of the three-channel waveguide combiner respectively causes display of images of one color of the three colors generated by the light emitters; and
optically aligning the collimating optics with the three-channel waveguide combiner for causing display of augmented-reality content to a wearer of the augmented-reality glasses.

18. The method of assembling the augmented-reality glasses of claim 17, wherein each channel of the three-channel waveguide combiner maintains a respective angular alignment for each of the three colors.

19. The method of assembling the augmented-reality glasses of claim 17, wherein the three-channel waveguide combiner is an optical waveguide with pupil replication.

20. The method of assembling the augmented-reality glasses of claim 17, wherein the optical coupler is an in-coupling optical element for coupling the collimated light into the three-channel waveguide combiner.
